(19) United States
(12) Patent Application Publication
(10) Pub. No.: US 2010/0310882 A1
(43) Pub. Date: Dec. 9, 2010

(54) TOPCOAT

(75) Inventors: Masahiko Ogawa, Yamagata-shi (JP); Miwa Tada, Yamagata-shi (JP)

Correspondence Address: Law Office of Katsuhiro Arai, 22471 Aspan Street, Suite 205 C, Lake Forest, CA, 92630, US

(73) Assignee: MIDORI HOKUYO CO., LTD., Yamagata-shi (JP)

(21) Appl. No.: 12/810,632

(22) PCT Filed: Dec. 26, 2008
(86) PCT No.: PCT/JP2008/004013

§ 371 Date: Jun. 25, 2010

(30) Foreign Application Priority Data
Dec. 27, 2007 (JP) 2007-337739

(51) Int. Cl. C14C 9/00; B32B 27/06; B05D 3/10

(52) U.S. Cl. 428/423.4; 252/8.57; 427/387

(57) ABSTRACT

This invention provides a natural leather having a coating film as a topcoat layer that can suppress and prevent the occurrence of an uncomfortable squeak noise and, at the same time, has softer feeling, soft and smooth feeling, and slick feeling, a composition for the formation of a coating film on a natural leather, and a process for producing a natural leather. The natural leather comprises, as a topcoat layer, a coating film comprising 48 to 55% by weight of a two-component aliphatic polyurethane, 3 to 7% by weight of silica fine particles, 23 to 37% by weight of a cross-linking agent, and 7 to 13% by weight of a silicone touch agent (the total of the components being 100% by weight), wherein, in the coating film as the topcoat layer, the two-component aliphatic polyurethane contains 12 to 25% by weight, based on the solid content, of a polyurethane resin matting agent, or wherein, in the coating film as the topcoat layer, the two-component aliphatic polyurethane is contained in an amount of 51 to 55% by weight based on the solid content and further contains 6 to 10% by weight, based on the solid content, of a two-component aliphatic polyurethane/acryl emulsion.

### TECHNICAL FIELD

The present invention relates to a topcoat that reduces and suppresses generation of squeak noise often associated with natural leathers, while offering softness, flexibility, smooth touch and slick texture.

### RELATED ART

The leather manufacturing process comprises preparation, followed by a tanning step, neutralization step, re-tanning step, dyeing/greasing step, and finishing step where a coating film is formed.

In the finishing step where a coating film is formed, a coating film comprising three layers including the base coat layer, color coat layer and topcoat layer is formed on the natural leather that has been re-tanned, dyed and greased.

The topcoat layer plays an important role in that it adds wear resistance and flexibility to the leather and also gives the color and texture unique to leathers.

Traditionally aniline finish has been used to form this coating film, because it can create a coating film having high transparency and the surface pattern inherent to leathers. Modified versions of aniline finish include aniline-like finish, semi-aniline finish and covering finish. In addition to these finishing processes, polymer, polymer emulsion and water-based polymer emulsion are also used to form a coating film. For this purpose, polyurethane resin, acrylic resin and polyurethane-acrylic resin polymers have been widely used.

For the material used in the forming of coating film, where the aim is primarily to form a strong coating film using polyurethane emulsion, water-based polyurethane has been used in recent years to protect the environment, etc. In the polyurethane forming process, water-based two-component polyurethane made by mixing isocyanate and polyol together has been adopted. Known specifications of such water-based two-component polyurethane include one where blocked isocyanate prepolymer is emulsified and then aliphatic polyol containing amino groups is added to the resulting water-based dispersant (Patent Literature 1, Examined Japanese Patent Laid-open No. Hei 3-70752), and another where bifunctional isocyanate is caused to react with a bifunctional polyhydroxyl compound, chain extender and chain reaction inhibitor to produce polyurethane containing terminal aromatic amino groups (Patent Literature 2, Japanese Patent Laid-open No. Sho 60-161418).

When actually forming a polyurethane layer, a water-based polyurethane preparation constituted by polyurethane, where such polyurethane comprises organic isocyanate having a specific number-average molecular weight, and carboxylic acid containing bivalent alcohol and hydroxy group, can be used as a leather coating agent for low-gloss car seats, etc. (Patent Literature 3, Published Japanese Translation of PCT International Patent Application No. 2005-530868).

Also known is a polyurethane solution in organic solvent, where the polyurethane constituting such polyurethane solution contains a reaction product of the following composition: (a) multifunctional (at least bifunctional) polyol whose number-average molecular weight is 500 to 16000; (b) multifunctional (at least bifunctional) polyisocyanate whose number-average molecular weight is 140 to 1500; (c) if required, multifunctional (at least bifunctional) low-molecular-weight alcohol and/or amine whose number-average molecular weight is 32 to 500; and (d) at least one mono-amino functional heterocyclic compound (Patent Literature 4, Japanese Patent Laid-open No. 2000-319n347).

All of the above provide a material to form a coating film on leather surface. However, no descriptions are found as to the specific properties of the coating film each material is used to form, and in this regard not enough information is available.

When forming a coating film layer on the surface of natural leather, the aim is to form a coating film layer having the inherent characteristics required of such coating film and also meeting the needs of the time.

A cover material offering wear resistance, maintaining softness and offering improved touch is known, where the topcoat layer comprises urethane and silicone and where carbon nano-tube, etc., is added to adjust the surface roughness Ra to a range of 0.5 to 30 μm in the standard condition (Patent Literature 5, Japanese Patent Laid-open No. 2006-307397).

The film thickness of the topcoat layer is adjusted to a range of 20 to 40 μm, thicker than the topcoat layers of normal natural leathers, while the surface roughness is adjusted to a range of 0.5 to 30 μm by adding carbon nano-tube of 1.0 mμ or less in grain size. These adjustments reportedly help improve touch, enhance wear resistance and suppress abnormal noises. Since this level of film thickness is excessive for the topcoat layer, however, not much is expected when it comes to improving the touch and wear resistance of natural leather. As for abnormal noises, they are defined as abnormal noises generated by rubbing of the leather in question against clothes or another leather. In the latter case, abnormal noises are caused by two leathers rubbing against each other in a condition not receiving pressure, and do not refer to squeak noise.

Oftentimes the market demands for coating films to be formed on the surface of natural leathers in recent years have been to provide softness, flexibility, smooth touch and slick characteristics, rather than improving the material properties to ensure strength as has been the case in the past. There is also a strong need to suppress or prevent generation of squeak noise that would occur when a natural leather with a coating film formed on its surface comes in contact with another natural leather used for a different member and also having a coating film formed on its surface.

A large force is needed to cause two leathers, which are statically in contact with each other under pressure, to rub against each other. Squeak noise generates when this rubbing occurs.

Solving the aforementioned problem is difficult in that even if a coating film offering improved levels of softness, flexibility and smooth touch can be achieved, such coating film does not necessarily reduce or suppress generation of squeak noise or offer wear resistance or appropriate anti-slip property.

Furthermore, many inventions are already available in the field of synthetic leathers used for automobiles, with the aim of providing solutions for suppression and prevention of squeak noise, as explained later. These inventions target synthetic leathers used for resin seats, which are different in hardness and other properties from natural leathers having a coating film of improved softness, flexibility and smooth touch. Accordingly, countermeasures for suppression and prevention of squeak noise for synthetic leathers cannot be applied directly to natural leathers and if they are applied, squeak noise cannot be suppressed/prevented effectively.

With respect to the coating film of topcoat layer for natural leathers, suppressing and preventing uncomfortable squeak noise as much as possible, while achieving a coating film offering wear resistance and appropriate anti-slip property as well as softness, flexibility, smooth touch and slickness, presents a problem affecting the formation of coating films on natural leathers as a whole and which are separately decidable.

Specific examples of solutions for synthetic leathers are mentioned below:

Use a copolymer obtained by causing reactive silicone, polyol and isocyanate to react against one another (Patent Literature 6, Japanese Patent Laid-open No. Sho 63-317514); contain curable polyurethane comprising a mixture of polyisocyanate and polyol, and curable silicone as coating-film forming elements (Patent Literature 7, Japanese Patent Laid-open No. Sho 61-138636); processing agent used to add fine urethane resin grains to silicone-copolymerized curable urethane resin by 1 to 50 percent by weight of solid content (Patent Literature 8, Japanese Patent No. 3287867, Japanese Patent Laid-open No. 5-156206); acrylic-polyvinyl pigmented coating composition containing urethane grains and spherical polyethylene wax (Patent Literature 9, Japanese Patent Laid-open No. Hei 8-176491, Japanese Patent No. 3276257; Patent Literature 10, Japanese Patent Laid-open No. Hei 8-27409; Patent Literature 11, Japanese Patent Laid-open No. Hei 08-179780; Patent Literature 12, Japanese Patent Laid-open No. Hei 8-281210); processing agent containing urethane resin by 0.25 part by weight or more but not more than 9 parts by weight relative to 1 part by weight of silicone denatured acrylic resin (Patent Literature 13, Japanese Patent Laid-open No. Hei 8-183945); composition containing polytetrafluoroethylene powder resin and resin binder (Patent Literature 14, Japanese Patent Laid-open No. 2000-026787); processing agent containing ceramic grains for preventing squeak noise (Patent Literature 15, Japanese Patent Laid-open No. 2006-28444); and others.
Patent Literature 1: Examined Japanese Patent Laid-open No. Hei 3-70752
Patent Literature 2: Japanese Patent Laid-open No. Sho 60-161418
Patent Literature 3: Published Japanese Translation of PCT International Patent Application No. 2005-530868
Patent Literature 4: Japanese Patent Laid-open No. 2000-319347
Patent Literature 5: Japanese Patent Laid-open No. 2006-307397
Patent Literature 6: Japanese Patent Laid-open No. Sho 63-317514
Patent Literature 7: Japanese Patent Laid-open No. Sho 61-138636
Patent Literature 8: Japanese Patent Laid-open No. Hei 5-156206, Japanese Patent No. 3287867 Specification
Patent Literature 9: Japanese Patent Laid-open No. Hei 8-176491, Japanese Patent No. 3276257
Patent Literature 10: Japanese Patent Laid-open No. Hei 8-27409
Patent Literature 11: Japanese Patent Laid-open No. Hei 8-179780
Patent Literature 12: Japanese Patent Laid-open No. Hei 8-281210
Patent Literature 13: Japanese Patent Laid-open No. Hei 8-183945
Patent Literature 14: Japanese Patent Laid-open No. 2000-026787
Patent Literature 15: Japanese Patent Laid-open No. 2006-28444

### SUMMARY OF THE INVENTION

### Problems to be Solved by the Invention

The object of the present invention is to add to the coating film of topcoat layer for natural leathers the excellent wear resistance, softness, flexibility, smoothness and slick touch required of natural leathers, while preventing generation of uncomfortable squeak noise as much as possible, and also to provide a composition for forming a coating film on natural leather to obtain such coating film, natural leather having a coating film formed on its surface using such composition for forming a coating film on natural leather, and a method of forming such coating film.

### Means for Solving the Problems

The inventors studied in earnest to solve the aforementioned objects.
(1) The inventors examined ways to prevent as much as possible generation of uncomfortable squeak noise caused by a natural leather used for a car seat against the human body or another leather used in the reclining part, as well as requirements to be satisfied by a natural leather on which a coating characterized by wear resistance, softness, flexibility, smooth touch and slickness is formed.
(2) The inventors though that, to obtain a leather meeting these requirements to satisfy multiple conditions, it was necessary to clearly define the inherent elements of leather. When examining a leather constitution, basically the following elements are considered. These are requirements that must be satisfied at the same time, rather than those that can be prioritized. To be specific they are: (i) basic physical properties; (ii) appearance; and (iii) touch.
   (i) Items required as basic physical properties
   Specific requirements in this category are basic physical properties (wear resistance, bending resistance, light fastness, heat resistance, cold resistance, flexibility, and appropriate level of anti-slip property).
   All characteristics that constitute the basic physical properties are important. The wear resistance requirement involves use of a cross-linking agent to cross-link resins and thereby create a strong structure. It is not that specific resins are selected based on these characteristics. It is sufficient as long as resins are cross-linked using a cross-linking agent and that the resulting resin structure is hard.
   Resin type is another factor that affects bending resistance, light fastness, heat resistance, cold resistance, etc., and two-component polyurethane resin can be used favorably in this aspect. It is also possible to mix two-component polyurethane acrylic resin with the aforementioned two-component polyurethane resin. As for flexibility, suppleness is required. In this sense, two-component polyurethane resin and two-component polyurethane acrylic resin can be used favorably.
   When suitable substances are specified based on the aforementioned basic physical properties required, it is clearly effective to use two-component polyurethane resin and two-component polyurethane acrylic resin, and cross-link the two using a cross-linking agent (to an appropriate degree because excessive hardness is counter-effective).
   (ii) Items required for appearance
   The topcoat layer must have a matte appearance. Users dislike and shun away from those automobiles whose parts reflect irradiated light on their coating film and appear shining
   Specific methods to prevent the above problem include adding silica fine particles and using a polyurethane resin matting agent. However, silica fine particles tend to create a dry touch (dry, silky feel which is the opposite of slickness) and can also cause squeak noise, although they provide a significant matting effect. Accordingly, silica fine particles must be combined with a polyurethane resin matting agent, as explained below.
   A polyurethane resin matting agent comprises polyurethane resin containing fine polyurethane grains, and these fine grains present at the surface diffuse light and thereby achieve a matting effect. Although squeak noise can be reduced with certainty, this type of agent cannot fully remove the luster. Accordingly, it is effective to combine silica fine particles and polyurethane resin matting agent in order to achieve a matting effect, produce slickness and reduce squeak noise sufficiently.
   (iii) The surface must have a favorable touch.
   Touch is how a person feels when touching an object. It can be described as dry, wet, slick, cold, warm, etc., and use of touch agents is effective when adjusting the touch to meet specific targets. Primarily silicone-based touch agents are used.
   Also, use of a polyurethane resin matting agent is effective in producing slickness.
   (d) The following invention was completed as a result of examining the above requirements in a comprehensive manner:
   A composition for forming a coating film on natural leather, constituted by an aqueous emulsion that contains solid contents including 51 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight) and water, characterized by containing in the aforementioned two-component polyurethane a polyurethane resin matting agent by 12 to 25 percent by weight of the aforementioned solid contents and two-component aliphatic polyurethane acrylic emulsion by 6 to 10 percent by weight of the aforementioned solid contents. (Claim 2)
(3) The invention of (2) above is effective in reducing squeak noise, and in fact the level of squeak noise decreased significantly compared to when no polyurethane resin matting agent was used and only 10% or more of silica fine particles were added for matting purposes. However, squeak noise was still recognized slightly and therefore ways to further prevent squeak noise were explored.
Here, the following actions were needed to prevent squeak noise further:
   (a) The resin used in (2) contains two-component aliphatic polyurethane acrylic emulsion. Based on our experience, acrylic resin tends to generate squeak noise more than polyurethane resin. In (2), 6 to 10 percent by weight of two-component aliphatic polyurethane acrylic resin is used. This was reduced to 0 to achieve further improvement.
   (b) Generation of squeak noise cannot be prevented with traditional silicone-based touch agents that are normally normally used to improve wear resistance. Accordingly, a specific silicone-based touch agent that can prevent generation of squeak noise was used.
   (c) If the aforementioned specific silicone-based touch agent that can prevent generation of squeak noise is used for the purpose of reducing squeak noise, a sufficient level of wear resistance cannot be added and the resulting resin lacks wear resistance. To compensate for this drawback, the amount of cross-linking agent was increased to make the resin stronger.
   The above do not constitute major changes from the descriptions in the Claims.
   The following invention was developed based on the above points:
   A composition for forming a coating film on natural leather, constituted by an aqueous emulsion that contains solid contents including 48 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight) and water, characterized by containing in the aforementioned two-component polyurethane a polyurethane resin matting agent by 12 to 25 percent by weight of the aforementioned solid contents. (Claim 1)
(4) With respect to natural leathers on which a coating film was formed according to the above, whether or not each obtained coating film constituted by polyurethane would prevent generation of uncomfortable squeak noise as much as possible and also have wear resistance and appropriate anti-slip property as well as softness, flexibility, smooth touch and slickness, was checked by measurement test or feeling test and the results were found satisfactory.

### EFFECTS OF THE INVENTION

The present invention specifically provides, with respect to the topcoat layer for natural leathers, a composition forming a coating film on for natural leather mainly constituted by a two-component polyurethane resin and can form a coating film capable of preventing generation of squeak noise as much as possible and offering wear resistance and appropriate anti-slip property as well as softness, flexibility, smoothness and slick touch; a natural leather having a coating film formed on its surface using such composition for forming a coating film on natural leather; and a method of forming such coating film.

### BRIEF DESCRIPTION OF THE DRAWINGS

FIG. 1 shows a system for measuring dynamic friction force and static friction force to measure squeak noise.

FIG. 2 explains measured results of dynamic friction force and static friction force.

FIG. 3 also explains measured results of dynamic friction force and static friction force.

FIG. 4 shows measured results of dynamic friction force and static friction force based on weights of 1.6 kg and 3.2 kg according to Example 1 pertaining to the present invention.

FIG. 5 shows measured results of dynamic friction force and static friction force based on weights of 4.8 kg and 6.4 kg according to Example 1 pertaining to the present invention.

FIG. 6 shows measured results of dynamic friction force and static friction force based on weights of 8.0 kg and 9.6 kg according to Example 1 pertaining to the present invention.

FIG. 7 shows measured results of dynamic friction force and static friction force based on weights of 11.2 kg and 12.8 kg according to Example 1 pertaining to the present invention.

FIG. 8 shows measured results of dynamic friction force and static friction force based on weights of 1.6 kg and 3.2 kg according to Example 2 pertaining to the present invention.

FIG. 9 shows measured results of dynamic friction force and static friction force based on weights of 4.8 kg and 6.4 kg according to Example 2 pertaining to the present invention.

FIG. 10 shows measured results of dynamic friction force and static friction force based on weights of 8.0 kg and 9.6 kg according to Example 1 pertaining to the present invention.

FIG. 11 shows measured results of dynamic friction force and static friction force based on weights of 11.2 kg and 12.8 kg according to Example 2 pertaining to the present invention.

FIG. 12 shows measured results of dynamic friction force and static friction force based on weights of 1.6 kg and 3.2 kg according to Comparative Example 1 pertaining to the present invention.

FIG. 13 shows measured results of dynamic friction force and static friction force based on weights of 4.8 kg and 6.4 kg according to Comparative Example 1 pertaining to the present invention.

FIG. 14 shows measured results of dynamic friction force and static friction force based on weights of 8.0 kg and 9.6 kg according to Comparative Example 1 pertaining to the present invention.

FIG. 15 shows measured results of dynamic friction force and static friction force based on weights of 11.2 kg and 12.8 kg according to Comparative Example 1 pertaining to the present invention.

FIG. 16 shows measured results of dynamic friction force and static friction force based on weights of 1.6 kg and 3.2 kg according to Comparative Example 2 pertaining to the present invention.

FIG. 17 shows measured results of dynamic friction force and static friction force based on weights of 4.8 kg and 6.4 kg according to Comparative Example 2 pertaining to the present invention.

FIG. 18 shows measured results of dynamic friction force and static friction force based on weights of 8.0 kg and 9.6 kg according to Comparative Example 2 pertaining to the present invention.

FIG. 19 shows measured results of dynamic friction force and static friction force based on weights of 11.2 kg and 12.8 kg according to Comparative Example 2 pertaining to the present invention.

### DESCRIPTION OF THE SYMBOLS

1 Test piece of natural leather
2 Test piece of natural leather
3 Slider
4 Weight
5 Tensile tester
6 Friction table
A1 Static friction force
A2 Second static friction force
A3 Third static friction force
An nth static friction force (n is an integer of 4 or greater.)
B1 First concave peak of friction force
B2 Second concave peak of friction force
B3 Third concave peak of friction force
Bn nth concave peak of friction force (n is an integer of 4 or greater.)

### BEST MODE FOR CARRYING OUT THE INVENTION

Natural leathers are manufactured through a series of processing steps including a preparation step to prepare for tanning of the material leather, tanning step using a chrome or chrome-free tanning agent, re-tanning & dyeing/greasing step using a synthetic tanning agent, drying step, and finishing step. The aforementioned drying step further comprises a setter step, hang drying step, conditioning step, vibration step and buffing step. The aforementioned finishing step further comprises a back sizing step, base-coat layer forming step, color-coat layer forming step, top-coat layer forming step, vibration step, and splitting step.

These steps are being improved in terms of the conditions of individual steps and combinations thereof, etc., but it can be said that the operation performed in each step is independent and roughly fixed, which makes them “known” steps.

The coating film, which is the subject of the present invention, is the topcoat layer on the surface, where an important technical theme is how to form the coating layer.

The topcoat layer is formed on the base coat layer and color coat layer, and accordingly the present invention is explained with focus on the base-coat layer forming step, color-coat layer forming step and top-coat layer forming step.
(1) The base coat layer is the bottom layer constituting the layered coating film, and used to flatten the surface irregularities of the leather and make the leather surface stable so that further layers can be formed on top. To form this layer, a composition comprising resin, pigment, auxiliaries, touch agent, leveling agent and water is coated onto the leather surface. The ratio of solid contents, or specifically resin, pigment and auxiliaries, is 50 to 75:5 to 20:10 to 30 (total 100%, ratio by weight). For the resin, a two-component polyurethane resin is used. For the pigment, a pigment of a desired color is used. For the auxiliaries, various agents including surface active agent, thickening agent, adjusting agent and matte agent can be used. The ratio of resin, pigment, auxiliaries, touch agent and leveling agent on one hand, and water on the other, is 20 to 40:80 to 60 (total 100%, ratio by weight). The coating method is selected, as deemed appropriate, from brushing, spraying, curtain-coating and roll-coating an aqueous solution of the mixture. The coating amount is 70 to 150 g/m², and hot air is blown onto the coated surface to evaporate the water content. The film thickness is 20 to 50 μm.
Next, embossing is performed. Embossing is a type of forming where a high-pressure press is used to create surface irregularities on the leather surface to add various patterns (grain patterns) to the leather. This is followed by a drum milling step and staking step to adjust the looseness of leather fibers.
(2) The color coat layer is the intermediate layer in the coating film used to hold the pigment or dye that adds color to the leather, and is provided above the base coat on the leather. To form this layer, again a composition comprising resin, pigment, auxiliaries, cross-linking agent, touch agent and water is coated onto the leather surface. The ratio of solid contents, or specifically resin, pigment, auxiliaries, cross-linking agent and touch agent, is 45 to 75:10 to 30:0 to 15:0 to 20:0 to 10 (total 100%, ratio by weight). For the resin, a two-component polyurethane resin is used. For the pigment, a pigment of a desired color is used. For the auxiliaries, various agents including surface active agent (such as leveling agent), thickening agent and adjusting agent can be used. The ratio of resin, pigment, auxiliaries and touch agent on one hand, and water on the other, is 20 to 40:80 to 60 (total 100%, ratio by weight). The coating method is selected, as deemed appropriate, from brushing, spraying, curtain-coating and roll-coating an aqueous solution of the mixture. The coating amount is 20 to 70 g/m², and hot air is blown onto the coated surface to evaporate the water content. The film thickness is 5 to 25 μm.
(3) The topcoat layer is formed on the surface of the color coat layer. In the present invention, this topcoat layer is formed as a coating film layer constituted by polyurethane, where the coating layer suppresses and prevents generation of uncomfortable squeak noise as much as possible and also provides wear resistance, appropriate anti-slip property as well as softness, flexibility, smooth touch and slickness.

The present invention uses the following two types of composition for forming a coating film on natural leather, described in (a) and (b), to form the coating film layer:
(a) “A composition for forming a coating film on natural leather, constituted by an aqueous emulsion that contains solid contents including 51 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight) and water, characterized by containing in the aforementioned two-component polyurethane a polyurethane resin matting agent by 12 to 25 percent by weight of the aforementioned solid contents and two-component aliphatic polyurethane acrylic emulsion by 6 to 10 percent by weight of the aforementioned solid contents.” (Claim 2)
(b) “A composition for forming a coating film on natural leather, constituted by an aqueous emulsion that contains solid contents including 48 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight) and water, characterized by containing in the aforementioned two-component polyurethane a polyurethane resin matting agent by 12 to 25 percent by weight of the aforementioned solid contents.” (Claim 1)
Use of the aforementioned compositions for forming a coating film on natural leather has not heretofore been known.
The conditions in which to form the topcoat layer using the aforementioned compositions for forming a coating film on natural leather are explained below.
The coating method is selected, as deemed appropriate, from brushing, spraying, curtain-coating and roll-coating an aqueous solution of the mixture. The coating amount is 20 to 70 g/m², and hot air is blown onto the coated surface to evaporate the water content. The film thickness is 5 to 25 μm.
(a) “A composition for forming a coating film on natural leather, constituted by an aqueous emulsion that contains solid contents including 51 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight) and water, characterized by containing in the aforementioned two-component polyurethane a polyurethane resin matting agent by 12 to 25 percent by weight of the aforementioned solid contents and a two-component aliphatic polyurethane acrylic emulsion by 6 to 10 percent by weight of the aforementioned solid contents” (Claim 2) is explained below.

The aforementioned two-component aliphatic polyurethane is contained by 51 to 55 percent by weight (assuming that the solid contents of the sum of each component gives 100 percent by weight).

The two-component aliphatic polyurethane is the most widely used type of coating material used to form a topcoat layer on the surface of natural leather, and can sufficiently provide the required characteristics of the coating film for natural leather. For effective use as a topcoat layer, the two-component aliphatic polyurethane should be adjusted to a content in the aforementioned range.

This two-component polyurethane contains a two-component aliphatic polyurethane acrylic emulsion by 6 to 10 percent by weight of the aforementioned solid contents.

Just like the two-component polyurethane, this two-component aliphatic polyurethane acrylic emulsion is also flexible enough to be used as a coating-film forming material, and this point was considered in selecting this particular emulsion.

The silica fine particles are contained by 3 to 7 percent by weight.

A type of silica constituted by fine grains is used. These silica fine particles are used to provide a matting effect, or specifically to prevent the coating layer from shining There is no question that silica can achieve this matting effect.

However, use of silica fine particles tends to create a dry touch (dry, silky feel which is the opposite of slickness) and can cause squeak noise.

Accordingly, it is effective to also use a polyurethane resin matting agent in order to create slickness while ensuring sufficient matting.

However, the matting effect of any polyurethane resin matting agent is weaker than that of silica fine particles, and therefore it is not possible to use only a polyurethane resin matting agent in place of silica fine particles.

The aforementioned range of content of silica fine particles was determined as a result of the above.

The aforementioned two-component polyurethane contains a two-component polyurethane resin matting agent by 12 to 25 percent by weight of the aforementioned solid contents.

The polyurethane resin matting agent is constituted by polyurethane resin containing fine polyurethane grains, where the fine grains are scattered in the resin.

When combined with the aforementioned fine grains, this mixture serves as a matting agent and also creates slickness. However, the matting effect is not sufficient, although no problem is anticipated in terms of squeak noise because the mixture rarely causes this noise to generate.

As a result of the above, the two-component polyurethane contains this two-component polyurethane resin matting agent by 12 to 25 percent by weight of the aforementioned solid contents.

The cross-linking agent is contained by 23 to 37 percent by weight.

This cross-linking agent cross-links the two-component polyurethane and is required to make the resin harder and stronger and thereby improve the wear resistance of the topcoat layer.

On the other hand, excessive hardness is not desirable because it can cause squeak noise and may also negatively affect the touch. As a result, the cross-linking agent should be contained by 23 to 37 percent by weight.

The silicone-based touch agent is contained by 7 to 13 percent by weight.

The silicone-based touch agent is used to improve the touch (slickness) of the topcoat layer and also improve its wear resistance.

The solid contents comprise the aforementioned components in amounts within the specified ranges, and a mixture of these solid contents with water gives the composition for forming a coating film on natural leather. The amount of water is not specified and any amount can be determined as deemed appropriate by considering the specific operation of forming the coating film, as long as this operation can be implemented without problem.

In general, 150 to 400 percent by weight of water is added relative to the solid contents.

For the aforementioned composition for forming a coating film on natural leather, the essential components that must be contained in order to solve the object tackled by the present invention are specified. When forming the topcoat layer, other additives and auxiliaries such as any conventional leveling agent can be added, as well. For example, a pigment that serves as a coloring agent can be added to add color. Also, any surface active agent or other emulsifier, thickening agent, adjusting agent, consistency adjusting agent, wetting agent or thixotrope agent can be added. It is also possible to add a UV absorbent or other value-adding substance.

When any of the above agents is added, the adding substance or its amount must not negatively affect the actions of the essential components needed to solve the object. Accordingly, it is necessary to conduct a test or other experiment under potential undesirable scenarios and pay due attention to prevent harmful effects from other additives.
(b) “A composition for forming a coating film on natural leather, constituted by an aqueous emulsion that contains solid contents including 48 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight) and water, characterized by containing in the aforementioned two-component polyurethane a polyurethane resin matting agent by 12 to 25 percent by weight of the aforementioned solid contents” (Claim 1) is explained below.
This composition for forming a coating film on natural leather further prevents generation of squeak noise compared to the aforementioned composition in (a) (Claim 2).
To be specific, the two-component aliphatic polyurethane acrylic emulsion contained in the two-component aliphatic polyurethane in Claim 2 is not used because its acrylic resin component contributes to generation of squeak noise, and also a different silicone touch agent is adopted in light of its ability to prevent generation of squeak noise.
The specific components are explained below.

The two-component aliphatic polyurethane is contained by 48 to 55 percent by weight (assuming that the the solid contents of the sum of each component gives 100 percent by weight).

The aforementioned range of content of the two-component polyurethane includes 12 to 25 percent by weight of a polyurethane resin matting agent relative to the aforementioned solid contents.

The two-component aliphatic polyurethane is the most widely used type of coating material used to form a topcoat layer on the surface of natural leather, and can sufficiently provide the required characteristics of the coating film for natural leather. For effective use as a topcoat layer, the two-component aliphatic polyurethane should be adjusted to a content in the aforementioned range.

The aforementioned composition for forming a coating film on natural leather (Claim 2) contains a two-component aliphatic polyurethane acrylic emulsion by 6 to 10 percent by weight of the aforementioned solid contents. This emulsion is not used in the invention according to Claim 1 because its acrylic resin component causes squeak noise.

The silica fine particles are contained by 3 to 7 percent by weight.

A type of silica constituted by fine grains is used. These silica fine particles are used to provide a matting effect, or specifically to prevent the coating layer from shining There is no question that silica can achieve this matting effect.

However, use of silica fine particles tends to create a dry touch (dry, silky feel which is the opposite of slickness) and can cause squeak noise.

Accordingly, it is effective to also use a polyurethane resin matting agent in order to create slickness while ensuring sufficient matting.

However, the matting effect of any polyurethane resin matting agent is weaker than that of silica fine particles, and therefore it is not possible to use only a polyurethane resin matting agent in place of silica fine particles. The aforementioned range of content of silica fine particles was determined as a result of the above.

The aforementioned two-component polyurethane contains a two-component polyurethane resin matting agent by 12 to 25 percent by weight of the aforementioned solid contents.

The polyurethane resin matting agent is constituted by polyurethane resin containing fine polyurethane grains, instead of silica fine particles.

When combined with the aforementioned silica fine particles, this mixture serves as a matting agent and also creates slickness.

The two-component polyurethane contains this polyurethane resin matting agent by 12 to 25 percent by weight of the aforementioned solid contents.

The polyurethane resin matting agent is a virtually clear composition. The surface of polyurethane resin is formed with slight irregularities. This causes the light contacting the surface to diffuse, and this effect allows polyurethane resin to be used as a matting agent. Also, polyurethane resin makes up for the insufficient characteristics of silica fine particles added separately from the matting agent. However, the matting effect is not sufficient, although no problem is anticipated in terms of squeak noise because the mixture rarely causes this noise to generate.

As a result of the above, the two-component polyurethane contains this two-component polyurethane resin matting agent by 12 to 25 percent by weight of the aforementioned solid contents.

The cross-linking agent is contained by 23 to 37 percent by weight.

This cross-linking agent cross-links the two-component polyurethane and is required to make the resin harder and stronger and thereby improve the wear resistance of the topcoat layer.

On the other hand, excessive hardness is not desirable because it can cause squeak noise and may also negatively affect the touch. As a result, the cross-linking agent should be contained by 23 to 37 percent by weight.

The silicone-based touch agent is contained by 7 to 13 percent by weight.

The touch agent was changed to the silicone-based touch agent that does not generate squeak noise.

This silicone-based touch agent not only improves the touch (slickness) of the topcoat layer, but it also helps prevent squeak noise.

The solid contents comprise the aforementioned components in amounts within the specified ranges, and a mixture of these solid contents with water gives the composition for forming a coating film on natural leather. The amount of water is not specified and any amount can be determined as deemed appropriate by considering the specific operation of forming the coating film, as long as this operation can be implemented without problem.

In general, 150 to 400 percent by weight of water is added relative to the solid contents.

A natural leather having the target coating film formed on it can be obtained by coating the aforementioned composition for forming a coating film on natural leather in (a) or (b) on the surface of the color coat layer, and then heating and drying the coated surface under a temperature condition of 70° C. to 130° C.

When the topcoat layer is formed with each composition for forming a coating film on natural leather, the corresponding natural leather is obtained as specified below:
(a) A natural leather having a coating film formed on it, wherein such coating film is constituted by solid contents including 51 to 55 percent by weight of two-component aliphatic polyurethane, 3 to 7 percent by weight of silica fine particles, 23 to 37 percent by weight of cross-linking agent and 7 to 13 percent by weight of silicone-based touch agent (the solid contents of the sum of each component gives 100 percent by weight), and wherein the aforementioned two-component polyurethane contains a polyurethane resin matting agent by 12 to 25 percent by weight of the aforementioned solid contents and two-component aliphatic polyurethane acrylic emulsion by 6 to 10 percent by weight of the aforementioned solid contents. (Claim 4)
(b) A natural leather having a coating film formed on it, wherein such coating film is constituted by solid contents including 48 to 55 percent by weight of two-component aliphatic polyurethane, 3 to 7 percent by weight of silica fine particles, 23 to 37 percent by weight of cross-linking agent and 7 to 13 percent by weight of silicone-based touch agent (the solid contents of the sum of each component gives 100 percent by weight), and wherein the aforementioned two-component polyurethane contains a polyurethane resin matting agent by 12 to 25 percent by weight of the aforementioned solid contents. (Claim 3)

Each coating film thus obtained provided a coating film for topcoat layer of natural leather that suppresses and prevents generation of uncomfortable squeak noise as much as possible, and also offers wear resistance, appropriate anti-slip property, as well as softness, flexibility, smooth touch, and slickness. These coating film properties were confirmed using systems for measuring the respective properties.

The composition of each coating film for topcoat layer is the same as the corresponding composition for forming a coating film on natural leather mentioned above, excluding water, and the roles played by each component in the coating film are the same.

Each component used in the aforementioned compositions for forming a coating film on natural leather is explained below.

The two-component aliphatic polyurethane is explained below.

The two-component aliphatic polyurethane mentioned herein is water-based and used as a coating material.

When forming a coating film on natural leather, water-based polyol is mixed with a hardener constituted by water-based polyaliphatic isocyanate to cause a reaction.

The two-component aliphatic polyurethane presents a problem in terms of pot life, in that it must be coated or otherwise handled within a specified time. In the case of the present invention, however, the natural leather can be treated within a period 6 hours or so and therefore no operational problem is anticipated. The obtained coating film is stable and provides advantages including non-yellowing.

This water-based polyaliphatic isocyanate is manufactured as follows:

An aliphatic isocyanate such as an aliphatic isocyanate based on 1,4-diisocyanatebutane, 1,6-diisocyanatehexane, 1,5-diisocyanate-2,2-dimethylpentane, 2,2,4- or 2,4,4-trimethyl-1,6-diisocyanatehexane, 1,10-diisocyanatedecane or other isocyanate is denatured so that it contains a polyisocyanate containing the uretodione group, isocyanurate group, urethane group, allophanate group, burette group and/or oxadiazine group, and the obtained mixture is then caused to react with polyalkylene oxide polyether alcohol containing the ethylene oxide unit to manufacture a polyisocyanate mixture (as described in Japanese Patent No. 2961475 Specification, among others).

For the water-based polyol, a diol containing the carboxyl group such as dimethylolbutanoic acid, dimethylolpentanoic acid, dimethylolheptanoic acid, dimethyloloctanoic acid or dimethylolnonanoic acid can be used. Of these, dimethylolbutanoic acid, dimethylolheptanoic acid or dimethylolnonanoic acid is desirable from the viewpoint of their cost in industrial applications, and the most desirable of all is dimethylolbutanoic acid. Such diol containing the carboxyl group can be obtained by any known synthetic method, but normally it is obtained by causing alkyl aldehyde to react with formalin in the presence of a basic catalyst to cause aldol condensation, and then adding peroxide to oxidize the aldehyde group (as described in Japanese Patent No. 3493796 Specification and Japanese Patent Laid-open No. Hei 8-359884, among others).

In the mixing process, NCO/OH is adjusted to a range of 1.3 to 1.5.

The polyisocyanate component is caused to fully react with polymer polyol and low-molecular-weight chain extender to obtain polyurethane. Thereafter, a solvent that can be separated at will is used.

Also, a group that can be neutralized is converted to a salt to manufacture a dispersant using water. Depending on the neutralization level and content of ionic groups, this dispersant can be dispersed in a very fine form to create an appearance of solution.

A water-based two-component aliphatic polyurethane with a number-average molecular weight of 10000 or less can be manufactured as explained below.

The following two types of compositions, or (i) which is a composition constituted by (a) and (b) and (ii) which is a composition constituted by (c) and (d), are used together with (iii) (c) amine and (iv) water. (iii) and (iv) together act as a chain terminator.

First, components (a) and (b), and (c) and (d), are mixed and reacted together to obtain a NCO prepolymer, which is then mixed and reacted with component (e) water to obtain a polyurethane whose OH functionality is 2 to 6.

The reaction is implemented at a temperature of 70° C. or so.
(i) Use a composition constituted by (a) at least one type of polyol with a number-average molecular weight of 1500 to 3000 g/mol, and (b) at least one type of diol having a molecular weight of 61 to 499 g/mol.
To be specific, (a) “at least one type of polyol with a number-average molecular weight of 1500 to 3000 g/mol” is a reaction product of bivalent alcohol and dibasic carboxylic acid. Examples of the dibasic carboxylic acid include succinic acid, adipic acid, suberic acid, azelaic acid and sebacic acid, among others.
Examples of the bivalent alcohol include ethylene glycol, 1,2- or 1,3-propyleneglycol, 1,4-, 1,3- or 2,3-butyleneglycol, 1,6-hexanediol, 1,8-octanediol, neopentylglycol, 2-methyl-1,3-propanediol, diethyleneglycol, triethyleneglycol, tetraethyleneglycol, polyethyleneglycol, dipropyleneglycol, polypropyleneglycol, dibutyleneglycol and polybutyleneglycol, among others.
In addition, (b) “at least one type of diol having a molecular weight of 61 to 499 g/mol” is specifically ethyleneglycol, 1,4-butanediol, 1,6-hexanediol, neopentylglycol, trimethylpentane diol, propyleneglycol, 1,3-propanediol, 1,4-cyclohexanedimethanol, or any mixture thereof, but preferably 1,4-butanediol should be used.
(ii) Use a composition constituted by (c) aliphatic diisocyanate having a molecular weight of 168 to 262 g/mol and (d) at least one type of diol having at least one carboxyl or carboxylate group and whose molecular weight is smaller than 450 g/mol.
The aliphatic isocyanate in (c) is hexamethylenediisocyanate, butanediisocyanate or other isocyanate.
For (d), “diol having at least one carboxyl or carboxylate group,” dimethylolacetic acid, 2,2-dimethylolpropionic acid, 2,2-dimethylolbutyric acid, 2,2-dimethylolpentanoic acid, dihydroxysuccinic acid or other 2,2-bis(hydroxymethyl)alkanecarboxylic acid is appropriate.
(iii) As for (e), amine introduces the terminal hydroxyl group, while isocyanate mainly reacts with the amino group in the manufacturing method explained below when a polyurethane dispersant conforming to the present invention is used. For the compound of (e), ethanolamine, propanolamine, N-methylethanolamine, diethanolamine or N,N,N′-tris-2-hydroxyethyl-ethylenediamine can be used, for example, but preferably ethanolamine or diethanolamine is used.
(iv) As for (f), water further increases the mol mass of dispersant after dispersion. The NH₂ group is formed by a reaction with the NCO group, and a further reaction with the NCO group causes the mol mass to increase as a result of urea bond.
(v) The mol ratio of component polyol (a) and sum of polyols (b) and (d) is 1:2 to 1:3, while the mol ratio of the sum of polyols (a), (b) and (d) and isocyanate (c) is 1:1.2 to 1:1.7, and the OH functionality of polyurethane is 2 to 4.
(vi) The number-average molecular weight of the obtained polyurethane should preferably be 2500 to 10000 g/mol (Japanese Patent Laid-open No. 2000-119511).

Two-component aliphatic polyurethane resins have been widely known. Under the present invention, these two-component aliphatic polyurethane resins can also be used as deemed appropriate. In addition, two-component aliphatic polyurethane is also used as a polyurethane resin matting agent, and a portion of the two-component aliphatic polyurethane resin can be used as a two-component aliphatic polyurethane resin.

Any two-component aliphatic polyurethane available on the market can be purchased and used. Specific examples are shown below. A mixture of these products can also be used.

Finish PF, PE, PFM, Matting MA, HS, LV (manufactured by BASF)

Aquqlen Top 2002. A, 2003. A, 2006. B, 2007. A, 2020. A, D-2012. B, D-2017, D-2018. B (manufactured by Clariant)

BAYDERM Finish 60UD, 61UD, 65UD, 71UD, 85UD, HAT, LB, Hydroholac HW-G, UD-2, AQUADERM Matt 200 (manufactured by LANXESS)

WD-21-163, WT-2586, WT-2511, WT-13-493, WT-13-486, WT-13-986, WT-2533, WT-2585, WT-13-992, WT-13-492, WT-2524, RU-6125 (manufactured by Stahl)

For the cross-linking agent, the aforementioned water-based polyaliphatic isocyanate can be used. This type of cross-linking agent is widely known, and one example is found in Japanese Patent No. 2961475 Specification.

By using the OH group constituted by the aforementioned dimethylol alkanoic acid and polytetramethylene ether glycol, a water-based polyurethane resin with a number-average molecular weight of approx. 18000 to 35000 is obtained as a water-based polyurethane resin coating material (Japanese Patent No. 3493796 Specification and Japanese Patent Laid-open No. Hei 8-359884). In terms of the number-average molecular weight of polyurethane resin, a water-based polyurethane with a number-average molecular weight 12000 to 20000, or in a range of 35000, or even 70000 or so, is obtained. Here, the number-average molecular weight is measured by dissolving 1 percent by weight of the polyurethane resin of interest in tetrahydrofuran and then measuring this sample via GPC (Gel Meation Chromatograph) and converting the result to a polystyrene equivalent value. This measuring method is hereinafter used for all measurements of molecular weights. The molecular weights of polyaliphatic isocyanate and polyol used in the reaction are adjusted according to the target final molecular weight of polyurethane.

An aliphatic isocyanate such as an aliphatic isocyanate based on 1,4-diisocyanatebutane, 1,6-diisocyanatehexane, 1,5-diisocyanate-2,2-dimethylpentane, 2,2,4- or 2,4,4-trimethyl-1,6-diisocyanatehexane, 1,10-diisocyanatedecane or other isocyanate is denatured so that it contains a polyisocyanate containing the uretodione group, isocyanurate group, urethane group, allophanate group, burette group and/or oxadiazine group, and the obtained mixture is then caused to react with polyalkylene oxide polyether alcohol containing the ethylene oxide unit to manufacture a polyisocyanate mixture.

Silica Fine Particles

Silica fine particles are also those of normally known properties, the specifics of which are explained below.

For these silica grains, silica fine particles with an average grain size (mode size) of 0.3 to 30 μm can be used.

For the silica fine particles, it is also effective to use organically coated fine silicic acid grains whose average grain size is 1 to 10 μm, or particularly 2 to 7 μm, and preferably having an oil number of 150 to 400 in accordance with ISO 787/5.

The solid ratio of polyurethane and silicic acid in the dispersant is 2:1 to 5:1. Preferably, such dispersant should contain residues of 1 to 8% after ignition. These are described in a Japanese patent application publication (Japanese Patent Laid-open No. 2000-119511). For each of the above types of silica fine particles, any commercially available product having a specific grain size can be purchased.

Silicone-Based Touch Agent

A licone-based touch agent is added to create a desirable touch of the topcoat film on the finished natural leather after the film has been formed. Examples include hydroxypolydimethylsiloxane, aminopolydimethylsiloxane, hydroxypolydiethylsiloxane, polydimethylpolyepoxidepolysiloxane, hydroxypolydiphenylsiloxane, aminopolydiethylsiloxane and dialkylsiloxane (the alkyl group should be a monovalent aliphatic hydrocarbon with 1 to 10 carbons, such as the methyl group, ethyl group or decyl group), among others. The molecular weight of any such reactive silicone should be approx. 200 to 10000, or preferably 300 to 9000, or more preferably 1000 to 5000.

For this silicone, any known silicone resin expressed by the general formula below can be used.

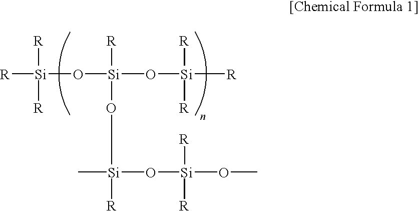

R is CH₃ or C₆H₅.

n is an integer of 10 or greater, but not greater than 100.

For this silicone, a modified type can be used.

A modified silicone represents a polydialkyl substituted polysiloxane having a functionality of 2 to 3. This alkyl group may have 1 to 10 carbons, and the functional group may be a carbinol group, amino group, thiol group or epoxy group, for example. Examples include hydroxypolydimethylsiloxane (such as DC1248 or QA-3667 by Dow, or X-22-160C by Shin-Etsu Chemical), aminopolydimethylsiloxane (DC-536 by Dow or GP-4 by Genesee Polymer), and polydialpolyepoxidepolysiloxane.

These silicones have a molecular weight of approx. 200 to 10000.

Also, any reactive silicone, polyol or isocyanate can be used (Japanese Patent Laid-open No. 63-317514).

Use of such silicone can reduce friction force, improve slip characteristics, and enhance wear resistance, etc.

Any of the following products can be purchased and used:

Rosilk 2229W, 2000 (manufactured by LANXESS)

HM-183, HM-51-760, HM-18-639, HM-21-720, HM-13-843 (manufactured by Stahl) MELIO WF-5233, WF-5226 conc. (manufactured by Clariant)

Touch agents for prevention of squeak noise are listed below (all are silicone-based).

AQUADERM Additive SF, Additive GF (manufactured by LANXESS) HM-13-632, HM-13-363, HM-13-843 (manufactured by Stahl)

The polyurethane matting agent is explained below.

A polyurethane matting agent is a covering agent, literally used for the purpose of offering coverage, having slight gloss as well as slight re-lustering potential. It is a polyurethane mixture constituted by an isocyanate and hydroxy compound, and produced by a unique manufacturing method.

A specific example is described in Published Japanese Translation of PCT International Patent Application No. 2005-530868.

A water-based polyurethane preparation that contains, by 10 to 60 percent by weight, at least one polyurethane A constituted by:

monomer I (monomer I whose organic base skeleton does not have any alkyl group on the side, selected from aliphatic diisocyanatehexamethylenediisocyanate and 4,4′-diisocyanate-dicyclohexylmethane);

monomer II (monomer II whose organic base skeleton has at least one alkyl group on the side, selected from monoisocyanate, diisocyanate, polyisocyanate and any mixture thereof);

monomer III (bivalent polyesterpolyol or polyetherpolyol);

monomer IV (bivalent alcohol);

monomer V (hydroxycarboxylic acid);

monomer VI (polyamine);

monomer VII (amino alcohol); and

monomer VIII (monovalent polyether alcohol alkoxylated by alkylene oxide or monovalent polyether alcohol);

wherein the contents of introduced monomers I to VIII conform to the following conditions:

the (—OH+>N—H)/NCO equivalent ratio of monomer III/monomers I+II is 0.1 to 0.75;

the (—OH+>N—H)/NCO equivalent ratio of monomer IV/monomers I+II is 0.2 to 0.8;

the (—OH+>N—H)/NCO equivalent ratio of monomer V/monomers I+II is 0.05 to 0.5;

the (—OH+>N—H)/NCO equivalent ratio of monomer VI/monomers I+II is 0 to 0.4;

the (—OH+>N—H)/NCO equivalent ratio of monomer VII/monomers I+II is 0 to 0.4;

the (—OH+>N—H)/NCO equivalent ratio of monomer VIII/monomers I+II is 0 to 0.2; and

the (—OH+>N—H)/NCO equivalent ratio of total sum of monomers III to VIII/monomers I+II is 0.80 to 1.25; and

wherein the total content of monomer I and monomer II is 50 to 100 percent by mol relative to monomer I, and 50 to 2000 mmol of the carboxy group constituting monomer V that has been introduced per 1 kg of polyurethane A in the water-based preparation exists as anions.

This polyurethane preparation contains insoluble grains in the polyurethane matrix, where the average diameter of these grains is 1 to 20 μm, or more favorably 2 to 15 μm, or even more favorably 3 to 10 μm, but especially 3 to 7 μm.

The polyurethane dispersant can contain any commercially available auxiliary or additive, such as foaming agent, defoaming agent, emulsifier, consistency preparation, wetting agent, thixotrope agent, or coloring agent such as dye or pigment.

This water-based polyurethane preparation is used favorably on leather to reduce gloss, while offering wear resistance, water stability, elasticity, slight re-lustering potential, dark color and pleasant, warm and soft touch.

Any of the following products can be purchased and used for this polyurethane matting agent:

NOVOMATT GG (manufactured by BASF)

Aquqlen Top DP-2100, Top DP-2055, Top DP-2100, MELIO 09-R-100 (manufactured by Clariant)

AQUADERM Matt 100 (manufactured by LANXESS)

WT-21-431, WT-21-412, WT-13-485, WT-13-985 (manufactured by Stahl)

Two-Component Aliphatic Polyurethane Acrylic Emulsion

Two-component aliphatic polyurethane acrylic emulsions are widely known, an example of which is described in Japanese Patent Laid-open No. Hei 5-320299.

A urethane prepolymer having a terminal isocyanate (—NCO) group is caused to react with an ethyleny unsaturated monomer having a hydroxyl (—OH) group in such a way that the (—OH/—NCO) equivalent ratio of the isocyanate group in the former prepolymer and hydroxyl group in the latter monomer becomes 0.3 to 0.6, to obtain a self-emulsifying denatured prepolymer having an ethyleny unsaturated bond and isocyanate group in the molecule, after which 100 parts by weight of a solid content of this self-emulsifying denatured prepolymer are mixed with 100 to 1000 parts by weight of an ethyleny unsaturated monomer whose main ingredient is an acrylic monomer, and a water dispersant of the resulting polymerized mixture is emulsion polymerized to obtain an aqueous emulsion of polyurethane acrylic resin.

The aforementioned urethane prepolymer having a terminal isocyanate group is explained below.

Example of such urethane prepolymer having a terminal isocyanate group are described in the Journal of Coating Technology, Vol. 58, No. 738, July 1986, pp. 49-51 and Japanese Patent Laid-open No. Sho 59-138211, where a polyol with a molecular weight of 200 to 4000 is reacted with a polyisocyanate compound having two or more isocyanate groups (—NCO) to obtain a urethane prepolymer, whose molecular weight is then increased further using a urethane chain extender, and the resulting urethane prepolymer with a terminal isocyanate group is ionized with an acid or alkali to obtain a self-emulsifying urethane prepolymer.

The material polyisocyanate for making this urethane prepolymer may be an aliphatic or alicyclic diisocyanate, such as 1,4-butylenediisocyanate, 1,6-hexanediisocyanate, 1,4-diisocyanatebutane, 1,6-diisocyanatehexane, 1,5-diisocyanate-2,2-dimethylpentane, 2,2,4- or 2,4,4-trimethyl-1,6-diisocyanatehexane or 1,5-naphthenediisocyanate, among others.

For the polyol, any polyol used for general urethane products can be used, such as any polyether, polyester, polyester amide, polythioether or polybutadieneglycol. Such polyether is produced by ring-opening addition polymerization, where water, ethyleneglycol, propyleneglycol, glycerin or other compound of active hydrogen is used as the initiator material and then ethyleneoxide, propyleneoxide, butyleneoxide, tetrahydrofuran, etc., is added to cause reaction.

The polyester is obtained through condensation of a saturated or unsaturated low-molecular glycol such as ethyleneglycol, propyleneglycol, 1,3-butanediol, 1,4-butanediol, neopentylglycol, pentanediol, hexanediol, octanediol, 2-ethyl-1,3-hexanediol, diethyleneglycol or dipropyleneglycol, with a dibasic acid. In addition to the above, any polythioether or polyacetal can be used. To obtain a urethane prepolymer using any of the above, normally a polyol of a low CPR (CPR conforms to JIS K 1557) is used to implement synthesis at a reaction temperature of approx. 30 to 150° C., where the blending mol ratio of polyisocyanate and polyol at the time of synthesis is 0.5 to 2.5 mol of isocyanate group per one hydroxyl group in the polyol.

The chain extender may be N-methyldiethanolamine, N-ethyldiethanolamine, N-oleyldiethanolamine, dimethylolpropionic acid, ethyleneglycol, diethyleneglycol, triethyleneglycol, propyleneglycol, dipropyleneglycol, 1,3-butyleneglycol, tetramethyleneglycol, hexamethyleneglycol, 1,4-butanediol, neopentylglycol or diaminoethane, 1,6-diaminohexane, piperazine, 2,5-dimethylpiperazine, 4,4′-diaminodicyclohexylmethane, 1,2-propylenediamine or hydrazine, among others.

For the ethyleny unsaturated monomer having a hydroxyl group, 2-hydroxyethylacrylate, 2-hydroxyethylmethacrylate, hydroxypropylacrylate, hydroxypropylmethacrylate, 2-hydroxy-3-chloropropylacrylate, acryloyloxyethylhydrogenphthalate, β-hydroxyethyl-β-acryloyloxyethylphthalate, 1,4-butyleneglycolmonoacrylate, N-methylolacrylamide, hydroxystyrene, vinylalcohol, arylalcohol, metharylalcohol, isopropenylalcohol, 1-butynylalcohol, ethyleneglycolmonoacrylate or 1,4-butanediolmonoacrylate can be used, among others.

A reaction product of the urethane prepolymer and ethyleny unsaturated monomer having a hydroxyl group has a free —NCO group but it reacts with active hydrogen and thus is not desirable. Accordingly, this —NCO group is masked by glycerin, caprolactam or other masking agent and ionized using an acid, alkali, etc. For this alkali, tertiary amine or ammonia is used. For the acid, hydrochloric acid or other inorganic acid, or acetic acid or other organic acid, is used.

Any of the following products can be purchased and used:

Hydrholac TS, CR-5 (manufactured by LANXESS)

WT-7370, WT-21433, RH-6677, RH-6663, RH-6659, RH-6671, RH-6698 (manufactured by Stahl)

The topcoat layer conforming to the present invention is formed in the coating process.

Specifically, the present invention provides a method for forming a coating film on natural leather, wherein either of the aforementioned compositions for forming a coating film on natural leather is coated on the surface of natural leather as the topcoat and then dried with heat the coated surface under a temperature condition of 70° C. to 130° C. to form a coating film.

The forming a coating film process is where a coating material is applied on the surface of leather that has been greased and heated, to form a coating film.

A coating film may be formed in multiple stages. For example, the process may involve application of a base coat for hiding the color or flaws of the base, color coat to match a specific color if required, and/or topcoat for improving the wear resistance and touch of the surface by means of coating.

The most important step is one of forming a topcoat, where normally a resin containing polyurethane resin and (/or) polyurethane acrylic resin is used.

Under the present invention, one of the aforementioned compositions for forming a coating film on natural leather is used to form a coating film on the surface of natural leather.

These compositions are applied by brushing, spraying, curtain-coating or roll-coating. In general, they are applied by spraying at a rate of 20 to 60 g/cm².

One of the aforementioned compositions for forming a coating film on natural leather is applied as a topcoat on the surface of natural leather, after which the coated surface is dried with heat under a temperature condition of 70° C. to 130° C., where cross-linking also progresses concurrently with heating/drying. As the composition for forming a coating film on natural leather is heated, water is removed and consequently a stable topcoat is formed on the natural leather.

The composition for forming a coating film on natural leather is applied as uniformly as possible. To be specific, the finished topcoat layer should have a thickness of approx. 10 μm.

A coating film formed as above was measured and evaluated as explained below.

1 Measurement of Squeak Noise
(1) Measurement of Squeak Noise and Relationship of Static Friction Force and Dynamic Friction Force

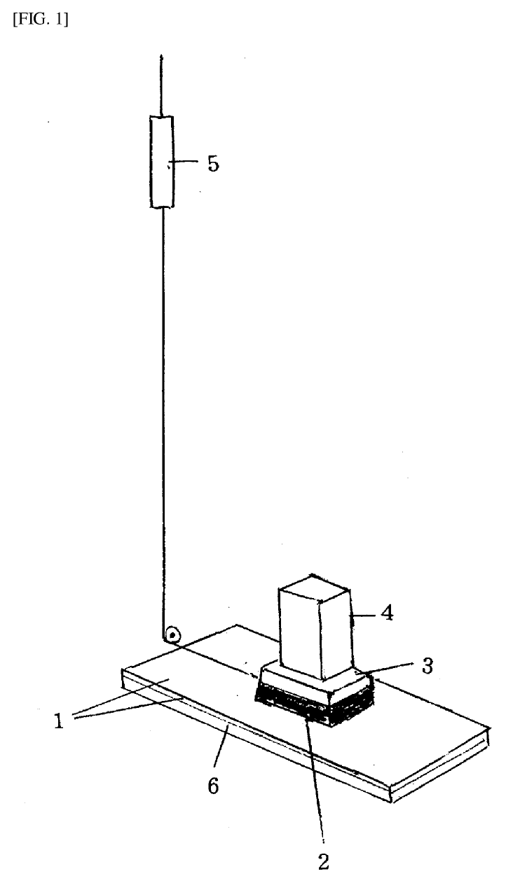

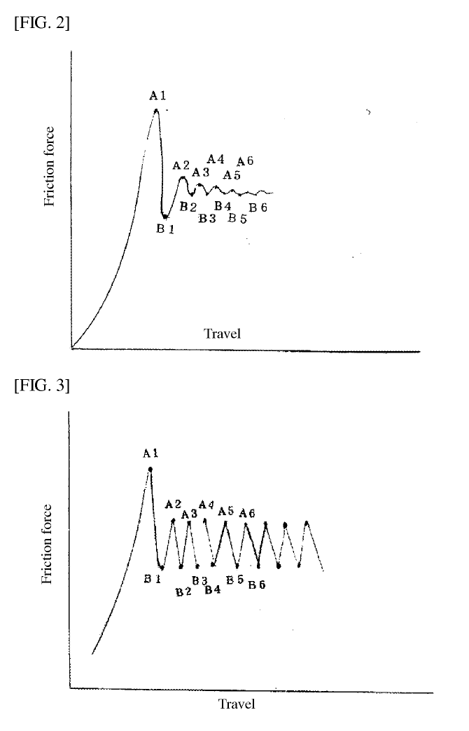

FIG. 1 shows a system for measuring squeak noise. FIG. 2 and FIG. 3 show measured results of static friction force and dynamic friction force.

Squeak noise of natural leather was measured by affixing a test piece of natural leather 1, which is one of the measurement targets, on a friction table 6, with another test piece of natural leather 2, being the other measurement target, affixed on a slider 3. A weight 4 is placed on the slider 3 to apply pressures, by means of the weight 4, onto the two measurement targets, or test pieces of natural leather 1 and 2. Both test pieces are affixed in a manner contacting each other.

Squeak noise is generated when two objects rub against each other while receiving pressure. A tensile tester 5 applies to the slider 3 a force (friction force) indicated on the tensile tester and the sound that generates when the slider 3 starts moving gives squeak noise.

The maximum value of the force (friction force) indicated on the tensile tester, measured at the start of slider movement, is static friction force A1.

Forces A and B are as follows:
A1 Static friction force
A2 Second static friction force
A3 Third static friction force
An nth static friction force (n is an integer of 4 or greater.)
B1 First concave peak of friction force
B2 Second concave peak of friction force
B3 Third concave peak of friction force
Bn nth concave peak of friction force (n is an integer of 4 or greater.)

The condition in which squeak noise generates when the slider 3 starts moving can be specified by the difference between the static friction force A1 when the slider 3 starts moving and the value of next concave peak B1 (A1−B1).

Once it starts moving, the slider 3 continues to move by repeatedly changing its speed according to the condition of contact between the surfaces of two natural leathers being measured, and squeak noise generates as the speed changes. The condition of speed change is measured based on the force (friction force) indicated on the tensile tester. The level of squeak noise is evaluated by the difference between the average convex peak and average concave peak on the chart, both of which are measured after the condition of speed change has stabilized.

On the whole, squeak noise can be described by examining the change in friction force at the start of slider movement, as well as change in friction force in a stable condition achieved thereafter.
(2) Measurement of Static Friction Force, Dynamic Friction Force, and Difference Between Concave and Convex Peaks of Dynamic Friction Force

The condition of squeak noise is expressed as follows.

The maximum value A1 by which the stationary slider 3 starts moving, being indicated on the tensile tester (friction force), is called “static friction force,” and the difference between this static friction force and the value of next concave peak B1 (A1−B1) is used to evaluate the squeak noise at the start of slider movement.

The change in speed after the start of slider movement is indicated by the concaving and convexing of the waveform of dynamic friction force. Sometimes the concave and convex peaks gradually decrease and finally converge into a flat line, as shown in FIG. 2, but other times the speed changes repeatedly with the two peaks remaining specific values, as shown in FIG. 3.

The difference between concave and convex peaks represents the average convex peak, less the average concave peak, in a slider travel range of 50 mm or more where the condition of speed change stabilizes.
(3) Judgment on Squeak Noise
(a) The smaller the value of static friction force less dynamic friction force, the less likely it is for squeak noise to generate. If this value, or A1−B1, is 2.5 N or less when a load of 12.8 kg is applied, squeak noise is small enough to present problems.
(b) The smaller the difference between the average convex peak and average concave peak (difference between concave and convex peaks) of the waveform of dynamic friction force, the less likely it is for squeak noise to generate.

To take values when the waveform is stable, peak values at a travel of 50 mm or more are used in the calculation.

If the calculated value is 0.2 N or less when a load of 12.8 kg is applied, squeak noise is small enough to present problems.

2 Measurement Procedure of Squeak Noise
(1) Affixing the Test Pieces

Affix on the friction table 6 a test piece 1 of natural leather 1, which is one of the measurement targets having a coating film formed on it, by attaching it on the surface of the table.

On the bottom surface of the slider 3 (a hexahedron whose bottom surface is 80 mm wide and 100 mm long) contacting this test piece 1, affix another test piece 2, being the other measurement target, in a manner free from slack.

Place the weight 4 on top of the slider 3 so that specific surface pressures can be applied to the test pieces 1, 2.

Change the mass of the weight to change the pressures applied onto the natural leathers being measured (specifically by changing the mass of the weight to eight levels associated with surface pressures of 20 to 160 g/cm²; all masses are expressed by equivalent test loads, with each load representing the total of weight and slider loads).

Test piece 1 of natural leather 1 200 mm long, 500 mm wide

Test piece 2 of natural leather 1 80 mm long, 200 mm wide

Slider 3 dimensions Hexahedron whose bottom surface is 80 mm wide, 100 mm long

The relationship of load and surface pressure is shown in the table below.

TABLE 1

| Surface pressure (g/cm²) | 20 | 40 | 60 | 80 | 100 | 120 | 140 | 160 |
|---|---|---|---|---|---|---|---|---|
| Load (kg) | 1.6 | 3.2 | 4.8 | 6.4 | 8 | 9.6 | 11.2 | 12.8 |

(2) Measurement Procedure

Connect the slider 3 and tensile tester 5 with a wire and use the tensile tester 5 to move the slider 3 at a pulling speed of 300 mm/min.
(3) Test Results

The travel of the slider 3 and force (friction force) indicated on the tensile tester were measured. The weight was changed and measurement was repeated by using the surface pressure as a variable. The results are shown in the figures (FIG. 2, FIG. 3).

Anti-Slip Property

While seated, the user feels unstable if the seating surface slips easily. Accordingly, automobile seats must be designed in a manner not causing the user to slip, and consequently leathers used on automobile seats require anti-slip property.

The aforementioned measurement method of squeak noise is changed as follows, with all other measurement conditions remaining the same.

Wool or jeans fabric is affixed onto the bottom surface of the slide 3 instead of the leather test piece 2, and the load is changed to 1.0 kg to measure the value of dynamic friction force for evaluating anti-slip properly. All concave peaks in a travel range of 0 to 100 mm are averaged to calculate the dynamic friction force. In the test using wool, the leather is deemed favorable for use on automobile seats when the dynamic friction force is 3.5 N or more. In the test using jeans fabric, the leather is deemed favorable for use on automobile seats when the dynamic friction force is 2.5 N or more.

Wear Resistance

Wear resistance is a particularly important performance required of leathers used on automobile seats. This wear resistance was evaluated by the Wyzenbeek wear test and Taber wear test.
(1) Wyzenbeek Wear Test
This test is conducted with a dry cloth or wet cloth.
If a dry cloth is used, wear resistance is evaluated as follows:
One test piece which is 230 mm long×approx. 60 mm wide is taken in the longitudinal direction (head-hip direction) and lateral direction (back-abdomen direction), respectively. Next, each test piece is affixed on the Wyzenbeek wear tester (Wyzenbeek Tester, manufactured by Schap Specialty Machine, Inc.) and then a dry cotton canvas cloth is placed on the friction piece and caused to contact the test piece.

The friction piece is moved back and forth to cause wear, and the number of wear cycles that caused the coating film to peel and base to be exposed is used to measure wear performance. Based on experience, the leather is deemed favorable for use on automobile seats when the result is 170 cycles or more.

If a wet cloth is used, wear resistance is evaluated as follows:

The aforementioned friction test is used after soaking long enough in water the cotton canvas cloth used on the friction piece. The method of friction test is the same as the one when a dry cloth is used. Based on experience, the leather is deemed favorable for use on automobile seats when the result is 50 cycles or more.
(2) Taber Wear Test
A test piece of 150 mm in diameter is attached to the table of the Taber rotary wear tester and then the tester is operated (at a rotational speed of 70 rpm) by placing on top of the test piece the CS-10 wear wheel receiving a load of 1 kg, and the dust collector is also operated at the same time. The test is conducted 2,000 times and thereafter the wear condition of the coating film is visually observed and graded.
The evaluation grades are as follows:
Grade 5: Wear is not observed at all.
Grade 4: Wear is recognized slightly, but inconspicuous.
Grade 3: Obvious wear is recognized, although slightly.
Grade 2: Wear is significant.
Grade 1: Wear is fairly significant.
Based on experience, the leather is deemed favorable for use on automobile seats when the grade is 4 or better.

Flexibility

Durability of coating film against rubbing is measured.

The measurement method is explained below.

Prepare two test pieces of the natural leather to be measured, in the size of 120 mm long×30 mm wide. Put the coated surfaces of the natural leather pieces together and set them on the Scott rubbing tester (manufactured by Tester Sangyo). Provide a grip margin of 30 mm and tighten the screw by making sure the test pieces are not displaced.

Perform the rubbing test 2,000 times at a load of 1 kg, travel of 50 mm and cycle speed of 120 laps/min. After the rubbing test, visually observe the coating surfaces on test pieces for cracking and peeling and determine the grade based on the results.

The evaluation grades are as follows:

Grade 5: Cracking/peeling is not observed at all.

Grade 4: Cracking/peeling is recognized slightly, but inconspicuous.

Grade 3: Obvious cracking/peeling is recognized, although slightly.

Grade 2: Cracking/peeling is significant.

Grade 1: Cracking/peeling is fairly significant.

The leather is deemed favorable for use on automobile seats when the grade is 5.

Cold Resistance and Heat Resistance

Cold resistance and heat resistance, which are important basic performance items of leathers used on automobile seats, were evaluated as follows:
(1) Cold Resistance
Prepare a test piece of 60 cm×90 cm. Cool this test piece for 90 minutes in a cold resistance tester whose temperature has been adjusted to −20° C., and then fold the test piece into two at 180° C. to visually check the coating film for cracking and make judgment.
Based on experience, the leather is deemed favorable for use on automobile seats when the coating film does not crack.
(2) Heat Resistance
Prepare a test piece of 60 cm×90 cm. Leave this test piece for 100 hours in a thermostatic layer whose temperature has been adjusted to 100° C. Next, remove the test piece and leave it at room temperature for 1 hour or so, and then visually compare it against an identical test sample not yet tested, to make judgment.
Indicate the judgment by a grayscale grade corresponding to the level of discoloration. Also evaluate the surface condition to see if there is any significant abnormality.
Based on experience, the leather is deemed favorable for use on automobile seats when the level of discoloration is grade 3 or better and the surface condition is free from significant abnormality.

Feeling Check of Touch
(1) Feeling Check of Touch (Squeak Noise)
Prepare a test piece of approx. 250 mm long×approx. 180 mm wide. Fold this test piece into two with the coated surface on the inside, and sandwich it with the thumb and index finger and apply a strong force to the fingers. Bring the test piece to the ear and move (slide) back and forth the fingers pinching the leather to check if squeak noise is heard. (Check for resistance due to friction, and sliding noise (caused by displacement), when the leathers firmly pinched with fingers are moved in different directions).
Evaluate “squeak noise” on a five-point scale from “1” representing large noise and “5” representing no noise. Five panelists give their respective scores, which are then averaged and rounded to an integer.
(2) Feeling Check of Touch (Slickness)
Prepare a test piece of approx. 250 mm long×approx. 180 mm wide.
Attach the leather test piece on a wooden or acrylic plate of the same size using double-sided adhesive tape, etc. Do not pull (stretch) the leather when attaching.
Place the test piece on the wooden or acrylic plate and firmly attach it onto the plate.
Five panelists are asked to touch the surface of the natural leather to be tested, being attached onto the wooden or acrylic plate, and evaluate the touch on a five-point scale.
“5” represents strong “slickness” which is a sensation felt upon touching, while “1” represents weak (or no) slickness.
The average of scores given by five panelists is rounded to an integer.
(3) Feeling Check of Touch (Slipperiness)
Conduct the test according to the same procedure for checking slickness to evaluate slipperiness, which is another sensation felt upon touching. Evaluation is made on a five-point scale, with “5” representing weak (no) slipperiness and “1” representing strong slipperiness. The average of scores given by five panelists is rounded to an integer.

A coating film comprising a base coat layer, color coat layer and topcoat layer was formed, in the finishing step, on the surface of natural leather according to each example explained below, and evaluated. The base coat layer and color coat layer of the evaluated coating film were formed in the exact same manner before the finishing step, and only the topcoat layer was formed differently as described below.

### EXAMPLE 1

Forming a Base Coat Layer
(1) A base coat was formed on the base surface of natural leather (after buffing). The procedure is explained below.
The base coat layer is the bottom layer constituting the layered coating film, and used to flatten the surface irregularities of the leather and make the leather surface stable so that further layers can be formed on top. To form this layer, a composition comprising resin, pigment, auxiliaries, touch agent, leveling agent and water was coated onto the leather surface.
The ratio of solid contents, or specifically resin, pigment and auxiliaries, was 60:15:25 (total 100%, ratio by weight). For the resin, a two-component polyurethane resin was used. For the pigment, a pigment of a desired color was used. For the auxiliaries, various agents including surface active agent, thickening agent, adjusting agent, matte agent and anti-tack agent were used.
The ratio of resin, pigment, auxiliaries, touch agent and leveling agent on one hand, and water on the other, was 35:65 (total 100%, ratio by weight). The coating method was selected, as deemed appropriate, from brushing, spraying, curtain-coating and roll-coating an aqueous solution of the mixture. The coating amount was 80 to 120 g/m², and hot air was blown onto the coated surface to evaporate the water content.
The various required grain patterns were formed by pressing (although they were formed on the base coat in this example, grain patterns may be formed after applying the color coat or topcoat).
The looseness of leather fibers was adjusted by the drum milling step and staking step (these steps may also be performed after applying the color coat or topcoat).
(2) A color coat was formed.
A color coat was formed on the surface of base coat. The color coat layer is the intermediate layer in the coating film used to hold the pigment or dye that adds color to the leather, and is provided above the base coat on the leather. To form this layer, again a composition comprising resin, pigment, auxiliaries, cross-linking agent and water was coated onto the leather surface. The ratio of solid contents, or specifically resin, pigment, auxiliaries and cross-linking agent, was 60:20:10:10 (total 100%, ratio by weight). For the resin, a two-component polyurethane resin was used. For the pigment, a pigment of a desired color was used. For the auxiliaries, various agents including surface active agent (such as leveling agent), thickening agent, adjusting agent, matte agent and anti-tack agent were used. The ratio of resin, pigment, auxiliaries and touch agent on one hand, and water on the other, was 30:70 (total 100%, ratio by weight). The coating method was selected, as deemed appropriate, from brushing, spraying, curtain-coating and roll-coating an aqueous solution of the mixture. The coating amount was 30 to 40 g/m², and hot air was blown onto the coated surface to evaporate the water content.
(3) A topcoat was formed on the surface of color coat. The topcoat layer is the top layer constituting the coating film and its composition is as stated separately. The coating amount was 30 to 40 g/m².

A composition for forming a coating film on natural leather constituted by 32 percent by weight of a two-component aliphatic polyurethane (number-average molecular weight 30000, viscosity 1700 mPa·s (25° C.)) relative to the solid contents, 18 percent by weight of a polyurethane matting agent relative to the solid contents, 35 percent by weight of a cross-linking agent, or isocyanate, relative to the solid contents, 4 percent by weight of silica fine particles relative to the solid contents, 11 percent by weight of a silicone touch agent relative to the solid contents (all of the foregoing constituted the solid contents) and water (the ratio of solid contents to water was 25 percent by weight to 75 percent by weight) was applied using a spray at a rate of 30 g/m².

Hot air of 40° C. to 50° C. was forcibly introduced to dry the composition to implement a cross-linking process.

A topcoat layer was formed as a coating film constituted by:

32 percent by weight of a two-component aliphatic polyurethane relative to the solid contents;

18 percent by weight of a polyurethane matting agent relative to the solid contents;

35 percent by weight of a cross-linking agent, or isocyanate, relative to the solid contents;

4 percent by weight of silica fine particles relative to the solid contents; and

11 percent by weight of a silicone touch agent relative to the solid contents.

The thickness of the layer was 10 μm.

The natural leather thus obtained was measured for generation of squeak noise.

The evaluation results are explained below.

Squeak Noise

The result of subtracting the first concave peak value of friction force B1 from the static friction force A1 was 10.35 N.

The band of change in dynamic friction force (difference between concave and convex peaks) was 0.132 N.

When a load of 12.8 kg was applied, the static friction force A1 was 38.60 N.

When a load of 12.8 kg was applied, the first concave peak value of friction force B1 was 28.25 N.

Anti-slip property
(Dynamic friction force when a load of 1 kg is applied)

| | |
|---|---|
| Attached white cloth | 3.63 N |

(The attached white cloth is the mono-filament cloth
used in the JIS color fastness test
(conforming to JIS L 0803), and the type of fiber is wool.)

| | |
|---|---|
| Jeans fabric | 3.04 N |

(Commonly used jeans fabric)

| | |
|---|---|
| Feeling test | |
| Squeak noise/5-point scale | 4.5 |
| Slickness/5-point scale | 5 |
| Slipperiness/5-point scale | 4 |
| Matting | |
| No problems were found. | |

Durability
Wear resistance

| | |
|---|---|
| Wyzenbeek values with dry cloth | |
| Lengthwise | 180 |
| Widthwise | 190 |
| Wyzenbeek values with wet cloth | |
| Lengthwise | 140 |
| Widthwise | 300 |
| Taber wear test | Grade 5 |
| Flexibility | Grade 5 |
| Cold resistance | (No cracks) |
| Heat resistance | (Grade 4.5/No abnormality |
| | in surface condition) |

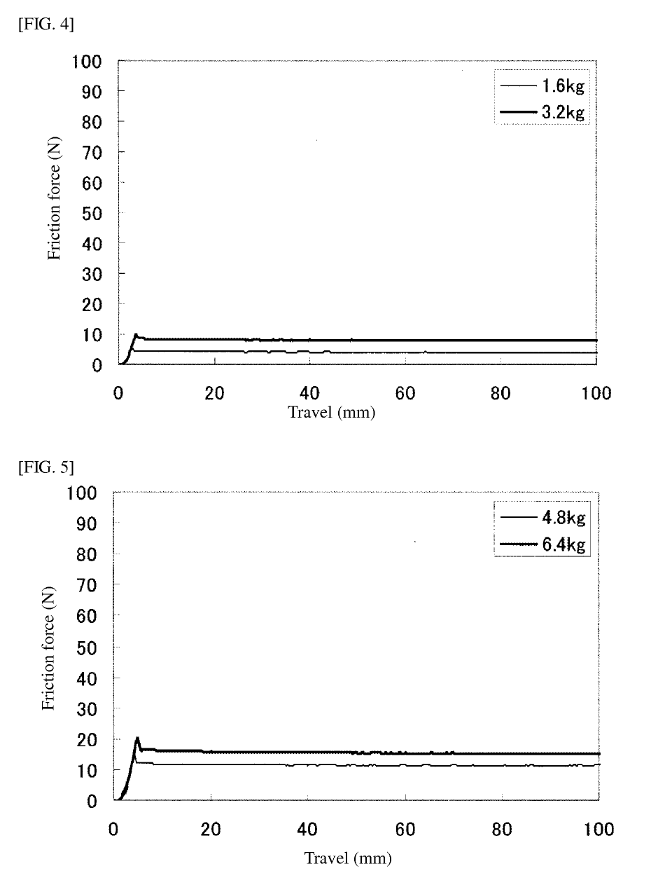

Charts obtained by the surface friction resistance test conducted to measure squeak noise are shown in FIGS. 4 to 7.

FIG. 4 shows measured results of dynamic friction force and static friction force using weights of 1.6 kg and 3.2 kg according to Example 1 of the present invention.

FIG. 5 shows measured results of dynamic friction force and static friction force using weights of 4.8 kg and 6.4 kg according to Example 1 of the present invention.

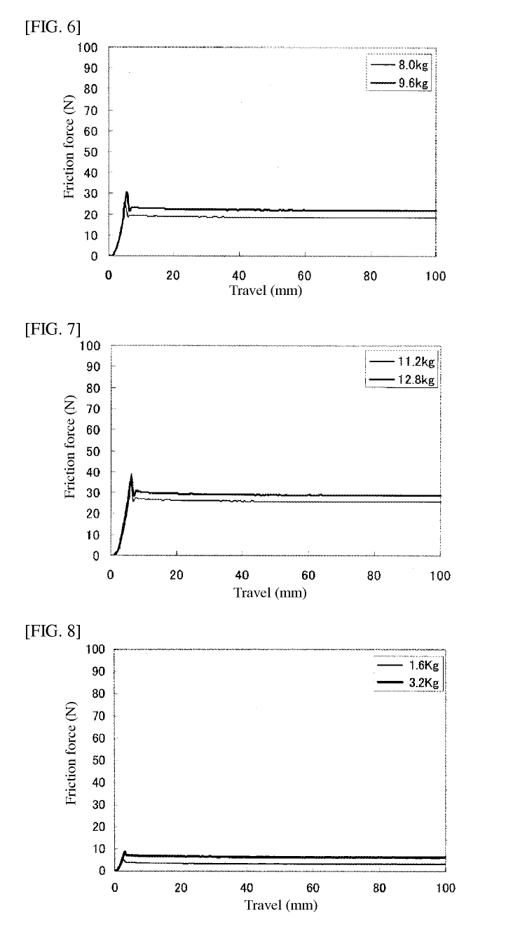

FIG. 6 shows measured results of dynamic friction force and static friction force using weights of 8.0 kg and 9.6 kg according to Example 1 of the present invention.

FIG. 7 shows measured results of dynamic friction force and static friction force using weights of 11.2 kg and 12.8 kg according to Example 1 of the present invention.

Table 2 lists these measured results of static friction force and dynamic friction force.

TABLE 2

| | Friction force (N) | | | | | |
|---|---|---|---|---|---|---|
| | | | | Average | Average | Difference |
| Load | | | | convex peak | concave peak | between concave |
| (kg) | A1 | B1 | A1 − B1 | value | value | and convex peaks |
| 1.6 | 5.1828 | 4.0266 | 1.1563 | 4.1156 | 4.0405 | 0.0751 |
| 3.2 | 9.7875 | 7.9 | 1.8875 | 8.0007 | 7.9142 | 0.0865 |
| 4.8 | 14.4891 | 11.3844 | 3.1047 | 11.5541 | 11.4557 | 0.0984 |
| 6.4 | 20.2984 | 15.3156 | 4.9828 | 15.4139 | 15.3129 | 0.101 |
| 8 | 24.6953 | 18.6219 | 6.0734 | 18.73 | 18.6387 | 0.0913 |
| 9.6 | 30.4594 | 21.3922 | 9.0672 | 22.2764 | 22.1632 | 0.1132 |
| 11.2 | 34.2797 | 25.8109 | 8.4688 | 25.9287 | 25.8032 | 0.1255 |
| 12.8 | 38.5953 | 28.2484 | 10.3469 | 29.0792 | 28.9468 | 0.1324 |

These results confirm that squeak noise had been eliminated. In other words, the results satisfy the objective of eliminating squeak noise.

### EXAMPLE 2

The details are the same as in Example 1 up to the formation of base coat.

A composition for forming a coating film on natural leather constituted by 35 percent by weight of a two-component aliphatic polyurethane resin (number-average molecular weight 25000, viscosity 1500 mPa·s (25° C.)) relative to the solid contents, 8 percent by weight of a two-component aliphatic polyurethane acrylic resin relative to the solid contents, 18 percent by weight of a polyurethane matting agent relative to the solid contents, 26 percent by weight of a cross-linking agent, or isocyanate, relative to the solid contents, 5 percent by weight of silica fine particles relative to the solid contents, 8 percent by weight of a silicone touch agent relative to the solid contents (all of the foregoing constituted the solid contents) and water (the ratio of solid contents to water was 23 percent by weight to 77 percent by weight) was applied using a spray at a rate of 40 g/m².

Hot air of 40° C. to 50° C. was forcibly introduced to dry the composition to implement a cross-linking process.

A coating film was formed on the surface of cowhide, wherein such coating film was constituted by:

35 percent by weight of a two-component aliphatic polyurethane resin relative to the solid contents;

8 percent by weight of a two-component aliphatic polyurethane acrylic resin relative to the solid contents;

18 percent by weight of a polyurethane matting agent relative to the solid contents;

26 percent by weight of a cross-linking agent, or isocyanate, relative to the solid contents;

5 percent by weight of silica fine particles relative to the solid contents; and

8 percent by weight of a silicone touch agent relative to the solid contents.

The thickness of the layer was 10 μm.

The leather thus obtained was measured for generation of squeak noise.

The evaluation results are explained below.

Squeak Noise

The result of subtracting the first concave peak value of friction force B1 from the static friction force A1 was 16.29 N.

The band of change in dynamic friction force (difference between concave and convex peaks) was 0.122 N.

When a load of 12.8 kg was applied, the static friction force A1 was 36.55 N.

When a load of 12.8 kg was applied, the first concave peak value of friction force B1 was 20.25 N.

Anti-slip property
(Dynamic friction force coefficient when a load of 1 kg is applied)

| | |
|---|---|
| Attached white cloth | 4.11 N |

(The attached white cloth is the mono-filament cloth used in the JIS color
fastness test (conforming to JIS L 0803), and the type of fiber is wool.)

| | |
|---|---|
| Jeans fabric | 3.14 N |

(Commonly used jeans fabric)

| | |
|---|---|
| Feeling test | |
| Squeak noise/5-point scale | 4 |
| Slickness/5-point scale | 4 |
| Slipperiness/5-point scale | 4 |
| Matting | |
| No problems were found. | |
| Durability | |
| Wear resistance | |
| Wyzenbeek values with dry cloth | |
| Lengthwise | 190 |
| Widthwise | 360 |
| Wyzenbeek values with wet cloth | |
| Lengthwise | 220 |
| Widthwise | 330 |
| Taber wear test | Grade 5 |
| Flexibility | Grade 5 |
| Cold resistance | (No cracks) |
| Heat resistance | (Grade 4.5/No abnormality |
| | in surface condition) |

Measured results of squeak noise are shown in FIGS. 8 to 11.

FIG. 8 shows measured results of dynamic friction force and static friction force using weights of 1.6 kg and 3.2 kg according to Example 2 of the present invention.

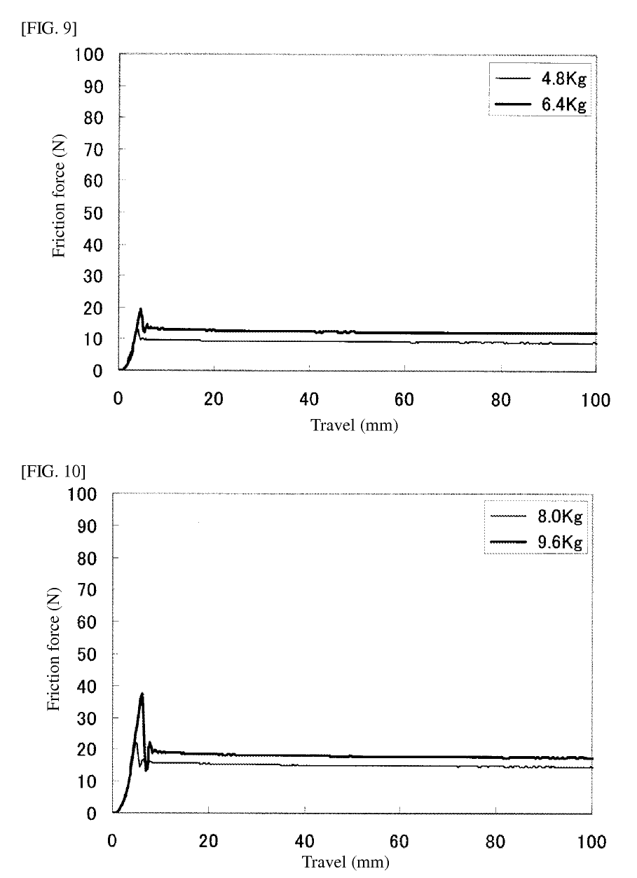

FIG. 9 shows measured results of dynamic friction force and static friction force using weights of 4.8 kg and 6.4 kg according to Example 2 of the present invention.

FIG. 10 shows measured results of dynamic friction force and static friction force using weights of 8.0 kg and 9.6 kg according to Example 1 of the present invention.

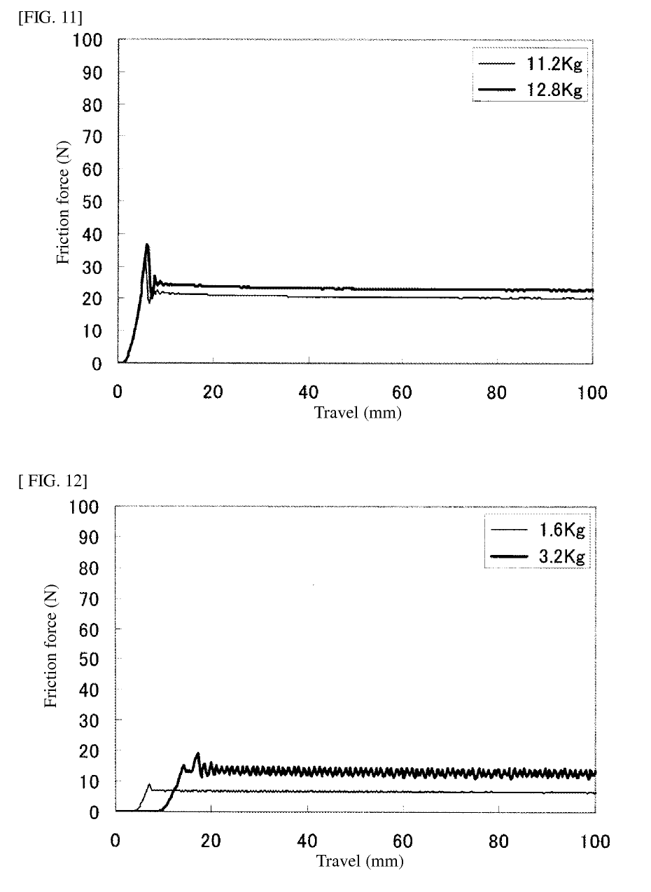

FIG. 11 shows measured results of dynamic friction force and static friction force using weights of 11.2 kg and 12.8 kg according to Example 2 of the present invention.

Table 3 lists these measured results of static friction force and dynamic friction force.

TABLE 3

| | Friction force (N) | | | | | |
|---|---|---|---|---|---|---|
| | | | | Average | Average | Difference |
| Load | | | | convex peak | concave peak | between concave |
| (kg) | A1 | B1 | A1 − B1 | value | value | and convex peaks |
| 1.6 | 5.3313 | 3.4297 | 1.9016 | 3.3295 | 3.2496 | 0.0799 |
| 3.2 | 8.8813 | 6.4188 | 2.4625 | 6.4732 | 6.3824 | 0.0908 |
| 4.8 | 13.1203 | 9.3391 | 3.7812 | 9.2563 | 9.1716 | 0.0847 |
| 6.4 | 19.6531 | 12.0703 | 7.5828 | 12.3736 | 12.2765 | 0.0971 |
| 8 | 22.0938 | 14.5562 | 7.5376 | 15.0019 | 14.9045 | 0.0974 |
| 9.6 | 37.3687 | 13.3047 | 24.064 | 17.9262 | 17.837 | 0.0892 |
| 11.2 | 31.6891 | 18.5766 | 13.1125 | 20.6689 | 20.5551 | 0.1138 |
| 12.8 | 36.5469 | 20.2547 | 16.2922 | 23.1976 | 23.0761 | 0.1215 |

These results confirm that squeak noise had been eliminated. In other words, the results satisfy the objective of eliminating squeak noise.

### COMPARATIVE EXAMPLE 1

A color coat layer was formed in the same manner as in Example 1.

A composition for natural leather constituted by 57 percent by weight of a two-component aliphatic polyurethane resin relative to the solid contents, 27 percent by weight of a cross-linking agent, or isocyanate, relative to the solid contents, 14 percent by weight of silica fine particles relative to the solid contents, 2 percent by weight of a silicone touch agent relative to the solid contents (all of the foregoing constituted the solid contents) and water (the ratio of solid contents to water was 23 percent by weight to 77 percent by weight) was applied using a spray at a rate of 35 g/m². Hot air of 40° C. to 50° C. was forcibly introduced to dry the composition to implement a cross-linking process.

As a result, a coating film was formed on the surface of cowhide, wherein such coating film was constituted by:

57 percent by weight of a two-component aliphatic polyurethane resin relative to the solid contents;

0 percent by weight of a two-component aliphatic polyurethane acrylic resin relative to the solid contents;

27 percent by weight of a cross-linking agent, or isocyanate, relative to the solid contents;

14 percent by weight of silica fine particles relative to the solid contents; and

2 percent by weight of a silicone touch agent relative to the solid contents.

The leather thus obtained was measured for generation of squeak noise.

### RESULTS

Squeak Noise

The result of subtracting the first concave peak value of friction force B1 from the static friction force A1 was 49.54 N.

The band of change in dynamic friction force (difference between concave and convex peaks) was 10.00 N.

When a load of 12.8 kg was applied, the static friction force A1 was 87.12 N.

When a load of 12.8 kg was applied, the first concave peak value of friction force B1 was 37.58 N.

Anti-slip property
(Dynamic friction force coefficient when a load of 1 kg is applied)

| | |
|---|---|
| Attached white cloth | 3.82 N |

(The attached white cloth is the mono-filament cloth
used in the JIS color fastness test
(conforming to JIS L 0803), and the type of fiber is wool.)

| | |
|---|---|
| Jeans fabric | 2.45 N |
| Feeling test | |
| Squeak noise/5-point scale | 2 |
| Slickness/5-point scale | 2 |
| Slipperiness/5-point scale | 2 |
| Matting | |
| No problems were found. | |

Durability
Wear resistance

| | |
|---|---|
| Wyzenbeek values with dry cloth | |
| Lengthwise | 60 |
| Widthwise | 60 |
| Wyzenbeek values with wet cloth | |
| Lengthwise | 40 |
| Widthwise | 30 |
| Taber wear test | Grade 3 |
| Flexibility | Grade 5 |
| Cold resistance | (No cracks) |
| Heat resistance | (Grade 4/No abnormality |
| | in surface condition) |

Measured results of squeak noise are shown in FIGS. 12 to 15.

FIG. 12 shows measured results of dynamic friction force and static friction force using weights of 1.6 kg and 3.2 kg according to Comparative Example 1 of the present invention.

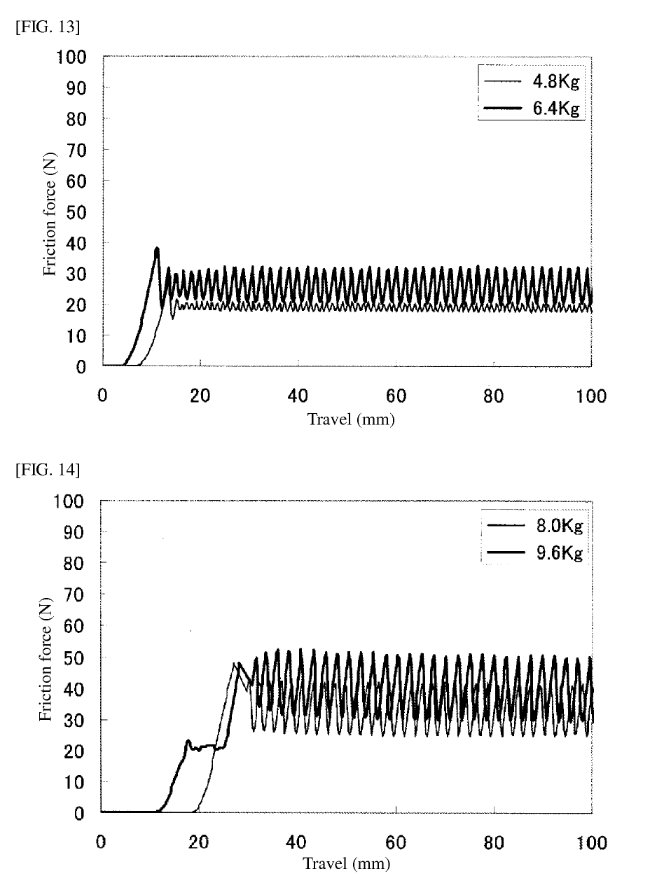

FIG. 13 shows measured results of dynamic friction force and static friction force using weights of 4.8 kg and 6.4 kg according to Comparative Example 1 of the present invention.

FIG. 14 shows measured results of dynamic friction force and static friction force using weights of 8.0 kg and 9.6 kg according to Comparative Example 1 of the present invention.

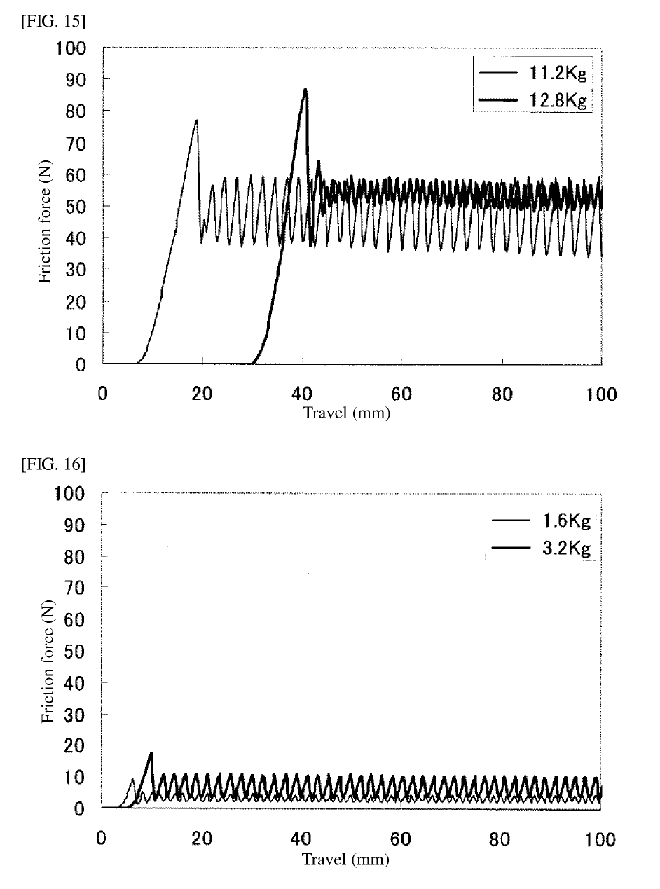

FIG. 15 shows measured results of dynamic friction force and static friction force using weights of 11.2 kg and 12.8 kg according to Comparative Example 1 of the present invention.

Table 4 lists these measured results of static friction force and dynamic friction force.

TABLE 4

| | Friction force (N) | | | | | |
|---|---|---|---|---|---|---|
| | | | | Average | Average | Difference |
| Load | | | | convex peak | concave peak | between concave |
| (kg) | A1 | B1 | A1 − B1 | value | value | and convex peaks |
| 1.6 | 9.2969 | 6.1609 | 3.1359 | 6.6859 | 6.1609 | 0.525 |
| 3.2 | 15.375 | 11.3578 | 4.0172 | 13.983 | 11.6523 | 2.3307 |
| 4.8 | 28.8219 | 15.2063 | 13.6156 | 20.4294 | 17.7323 | 2.6971 |
| 6.4 | 38.2531 | 18.8266 | 19.4265 | 32.0003 | 20.2065 | 11.7938 |
| 8 | 47.8531 | 24.8156 | 23.0375 | 41.173 | 24.7115 | 16.4615 |
| 9.6 | 23.3469 | 20.0109 | 3.336 | 50.1075 | 29.607 | 20.5005 |
| 11.2 | 77.0313 | 35.9688 | 41.0625 | 58.385 | 34.3941 | 23.9909 |
| 12.8 | 87.1156 | 37.5781 | 49.5375 | 58.3664 | 48.364 | 10.0024 |

These results confirm that squeak noise had been eliminated. In other words, the results satisfy the objective of eliminating squeak noise.

Clearly a significant level of squeak noise generated.

The levels of slickness and slipperiness are not satisfactory.

### COMPARATIVE EXAMPLE 2

A composition for natural leather constituted by 31 percent by weight of a two-component aliphatic polyurethane resin relative to the solid contents, 4 percent by weight of a two-component aliphatic polyurethane acrylic resin relative to the solid contents, 38 percent by weight of a cross-linking agent, or isocyanate, relative to the solid contents, 10 percent by weight of silica fine particles relative to the solid contents, 17 percent by weight of a silicone touch agent (all of the foregoing constituted a coating film) and water (the ratio of solid contents to water was 23 percent by weight to 77 percent by weight) was applied using a spray at a rate of 35 g/m². Hot air of 40° C. to 50° C. was forcibly introduced to dry the composition to implement a cross-linking process.

As a result, a coating film was formed on the surface of cowhide, wherein such coating film was constituted by:

31 percent by weight of a two-component aliphatic polyurethane resin relative to the solid contents;

4 percent by weight of a two-component aliphatic polyurethane acrylic resin relative to the solid contents;

38 percent by weight of a cross-linking agent, or isocyanate, relative to the solid contents;

10 percent by weight of silica fine particles relative to the solid contents; and

17 percent by weight of a silicone touch agent relative to the solid contents.

Hot air of 40° C. to 50° C. was forcibly introduced to dry the composition to implement a cross-linking process.

The leather thus obtained was measured for generation of squeak noise.

The evaluation results are explained below.

Squeak Noise

The result of subtracting the first concave peak value of friction force B1 from the static friction force A1 was 57.17 N.

The band of change in dynamic friction force (difference between concave and convex peaks) was 48.02 N.

When a load of 12.8 kg was applied, the static friction force A1 was 63.84 N.

When a load of 12.8 kg was applied, the first concave peak value of friction force B1 was 6.67 N.

Anti-slip property
(Dynamic friction force coefficient when a load of 1 kg is applied)

| | |
|---|---|
| Attached white cloth | 2.94 N |

(The attached white cloth is the mono-filament cloth used in the JIS color
fastness test (conforming to JIS L 0803), and the type of fiber is wool.)

| | |
|---|---|
| Jeans fabric | 1.96 N |
| Feeling test | |
| Squeak noise/5-point scale | 1 |
| Slickness/5-point scale | 1 |
| Slipperiness/5-point scale | 1 |
| Matting | |
| No problems were found. | |
| Durability | |
| Wear resistance | |
| Wyzenbeek values with dry cloth | |
| Lengthwise | 200 |
| Widthwise | 220 |
| Wyzenbeek values with wet cloth | |
| Lengthwise | 120 |
| Widthwise | 130 |
| Taber wear test | Grade 5 |
| Flexibility | Grade 5 |
| Cold resistance | (No cracks) |
| Heat resistance | (Grade 4.5/No abnormality |
| | in surface condition) |

FIG. 5 is a chart showing the measured results of squeak noise.

Clearly a significant level of squeak noise generated.

The levels of slickness and slipperiness are not satisfactory.

Measured results of squeak noise are shown in FIGS. 16 to 19.

FIG. 16 shows measured results of dynamic friction force and static friction force using weights of 1.6 kg and 3.2 kg according to Comparative Example 2 of the present invention.

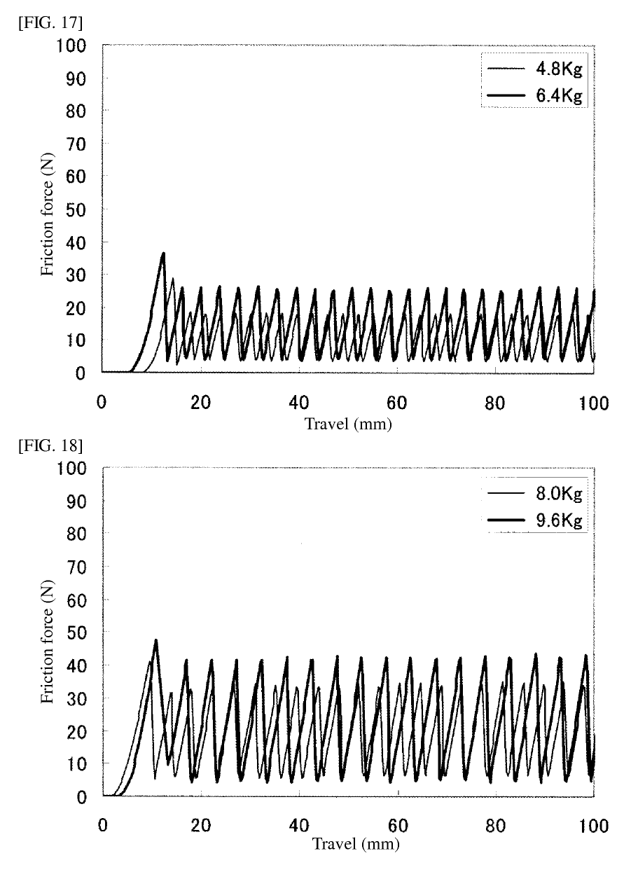

FIG. 17 shows measured results of dynamic friction force and static friction force using weights of 4.8 kg and 6.4 kg according to Comparative Example 2 of the present invention.

FIG. 18 shows measured results of dynamic friction force and static friction force using weights of 8.0 kg and 9.6 kg according to Comparative Example 2 of the present invention.

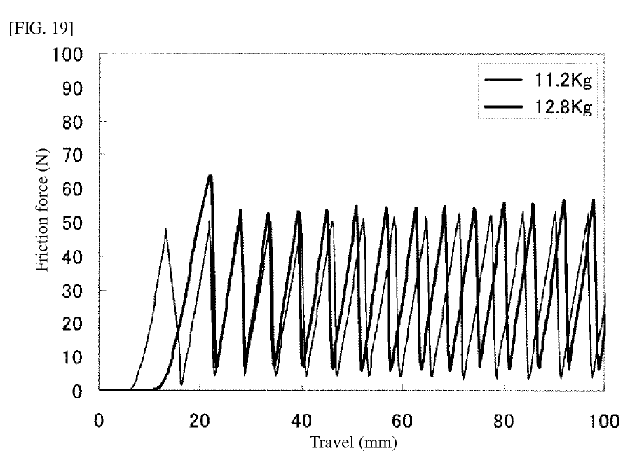

FIG. 19 shows measured results of dynamic friction force and static friction force using weights of 11.2 kg and 12.8 kg according to Comparative Example 2 of the present invention.

Table 5 lists these measured results of static friction force and dynamic friction force.

TABLE 5

| | Friction force (N) | | | | | |
|---|---|---|---|---|---|---|
| | | | | Average | Average | Difference |
| Load | | | | convex peak | concave peak | between concave |
| (kg) | A1 | B1 | A1 − B1 | value | value | and convex peaks |
| 1.6 | 9.3109 | 1.2688 | 8.0422 | 4.3926 | 2.2991 | 2.0935 |
| 3.2 | 17.565 | 2.8859 | 14.6791 | 10.3401 | 3.928 | 6.4121 |
| 4.8 | 28.8281 | 2.4219 | 26.4062 | 18.1907 | 3.843 | 14.3477 |
| 6.4 | 36.5219 | 3.8234 | 32.6985 | 25.9651 | 4.288 | 21.6771 |
| 8 | 41.4562 | 5.1828 | 36.2734 | 34.2848 | 6.4279 | 27.8569 |
| 9.6 | 47.7813 | 4.5531 | 43.2282 | 42.5379 | 5.1412 | 37.3967 |
| 11.2 | 47.8156 | 1.5938 | 46.2219 | 52.4759 | 4.2576 | 48.2183 |
| 12.8 | 63.8406 | 6.6719 | 57.1687 | 55.2067 | 7.1841 | 48.0226 |

Tables 6 and 7 summarize the conditions and evaluation results of the aforementioned examples and comparative examples.

TABLE 6
Composition percentages

| Main | | | | | | | | Comparative | Comparative |
|---|---|---|---|---|---|---|---|---|---|
| category | Sub category | Claim 1 | Claim 2 | Claim 3 | Claim 4 | Example 1 | Example 2 | Example 1 | Example 2 |
| Solid | Two-component | 48 to 55% | 51 to 55% | 48 to 55% | 51 to 55% | 32% | 35% | 57% | 31% |
| Contents | aliphatic | of solid | of solid | of solid | of solid | | | | |
| | polyurethane | contents | contents | contents | contents | | | | |
| | Polyurethane | 12 to 25 | 12 to 25 | 12 to 25 | 12 to 25 | 18 | 18 | | |
| | matting agent | | | | | | | | |
| | Two-component | | 6 to 10 | | 6 to 10 | 0% | 8% | 0% | 4% |
| | aliphatic | | | | | | | | |
| | polyurethane | | | | | | | | |
| | acrylic | | | | | | | | |
| | Isocyanate | 23 to 37 | 23 to 37 | 23 to 37 | 23 to 37 | 35% | 25% | 27% | 38% |
| | cross-linking | | | | | | | | |
| | agent | | | | | | | | |
| | Silica fine | 3 to 7 | 3 to 7 | 3 to 7 | 3 to 7 | 4% | 5% | 14% | 10% |
| | particles | | | | | | | | |
| | Silicone-based | 7 to 13 | 7 to 13 | 7 to 13 | 7 to 13 | 11% | 9% | 2% | 17% |
| | touch agent | | | | | | | | |
| | Total | 100 | 100 | 100 | 100 | | | | |
| | Water | Water | Water | No water | No water | | | | |

TABLE 7
Comparison of effects

| | | | | | | | Comparative | Comparative |
|---|---|---|---|---|---|---|---|---|
| Physical property | | | | Meaning | Example 1 | Example 2 | Example 1 | Example 2 |
| Touch | Squeak noise | Static friction force A1 | | Indicator of | 38.60 | 36.55 | 87.12 | 63.84 |
| | (Evaluated by the | | | resistance to slip | | | | |
| | friction force | First concave peak value of | | Indicator of speed at | 28.25 | 20.25 | 37.58 | 6.67 |
| | when a load of | friction force B1 | | start of slipping | | | | |
| | 12.8 kg was | A1 − B1 | | Indicator of squeak | 10.35 | 16.29 | 49.54 | 57.17 |
| | applied; unit N) | | | noise at start of | | | | |
| | | | | slipping | | | | |
| | | Band of change in dynamic | | Indicator of squeak | 0.132 | 0.122 | 10.00 | 48.02 |
| | | friction force coefficient | | noise during slip | | | | |
| | | (difference between concave | | motion | | | | |
| | | and convex peaks) | | | | | | |
| | Anti-slip property | Wool fabric | | Feeling of stability | 3.63 | 4.11 | 3.82 | 2.94 |
| | (Dynamic friction | Jeans fabric | | of seat | 3.04 | 3.14 | 2.45 | 1.96 |
| | force when a load | | | | | | | |
| | of 1 kg was | | | | | | | |
| | applied; unit N) | | | | | | | |
| | Feeling upon | Squeak noise | | No squeaking: 5 | 4.5 | 4 | 2 | 1 |
| | touch | Slickness | | Strong slickness: 5 | 5 | 4 | 2 | 1 |
| | | Slipperiness | | No slipping: 5 | 4 | 4 | 2 | 1 |
| Matting | | | | Comparison with | OK | OK | OK | OK |
| | | | | actual production | | | | |
| | | | | samples | | | | |
| Durability | Wear resistance | Wyzenbeek | (Lengthwise) | Number of wear | 180 | 190 | 60 | 200 |
| | | (dry) | (Widthwise) | cycles needed to | 190 | 360 | 60 | 220 |
| | | Wyzenbeek | (Lengthwise) | scratch coating film | 140 | 220 | 40 | 120 |
| | | (wet) | (Widthwise) | The greater the value, | 300 | 330 | 30 | 130 |
| | | | | the stronger the | | | | |
| | | | | coating film | | | | |

| | | | | | |
|---|---|---|---|---|---|
| Taber wear test | Strong coating film: 5 | Grade 5 | Grade 5 | Grade 3 | Grade 5 |

| | | | | | |
|---|---|---|---|---|---|
| Flexibility | Flexibility of coating | Grade 5 | Grade 5 | Grade 5 | Grade 5 |
| | film | | | | |
| Cold resistance | The coating film shall | No cracks | No cracks | No cracks | No cracks |
| | not crack. | | | | |
| Heat resistance | Discoloration: Grade | Grade 4.5 | Grade 4.5 | Grade 4 | Grade 4.5 |
| | 3 or better | | | | |
| | The surface condition | No | No | No | No |
| | shall be free from | abnormality | abnormality | abnormality | abnormality |
| | significant | in surface | in surface | in surface | in surface |
| | abnormality. | condition | condition | condition | condition |

1. A composition for forming a coating film on natural leather, which is constituted by an aqueous emulsion that contains solid contents including 48 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight) and water, characterized by containing in the two-component polyurethane a polyurethane resin matting agent by 12 to 25 percent by weight of the solid contents.

2. A composition for forming a coating film on natural leather, which is constituted by an aqueous emulsion that contains solid contents including 51 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight) and water, characterized by containing in the two-component polyurethane a polyurethane resin matting agent by 12 to 25 percent by weight of the solid contents and a two-component aliphatic polyurethane acrylic emulsion by 6 to 10 percent by weight of the solid contents.

3. A natural leather characterized by a coating film formed thereon as a topcoat, wherein the coating film is constituted by solid contents including 48 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight), said coating film containing in the two-component polyurethane a polyurethane resin matting agent by 12 to 25 percent by weight of the solid contents.

4. A natural leather having a coating film formed thereon, wherein the coating film is constituted by solid contents including 51 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight), said coating film being characterized by containing in the two-component polyurethane a polyurethane resin matting agent by 12 to 25 percent by weight of the solid contents and a two-component aliphatic polyurethane acrylic emulsion by 6 to 10 percent by weight of the solid contents.

5. A method of manufacturing natural leather of claim 3, characterized by:
applying on a surface of natural leather as a topcoat layer a composition for forming a coating film on natural leather, which is constituted by an aqueous emulsion that contains solid contents including 48 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight) and water, and which contains in the two-component polyurethane a polyurethane resin matting agent by 12 to 25 percent by weight of the solid contents,
drying with heat the coated surface under a temperature condition of 70° C. to 130° C., and
forming as a topcoat of the natural leather a coating film constituted by solid contents including 48 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight), said coating film containing in the two-component polyurethane a polyurethane resin matting agent by 12 to 25 percent by weight of the solid contents.

6. A method of manufacturing natural leather of claim 4, characterized by:
applying on a surface of natural leather as a topcoat layer a composition for forming a coating film on natural leather, which is constituted by an aqueous emulsion that contains solid contents including 51 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight) and water, and which contains in the two-component polyurethane a polyurethane resin matting agent by 12 to 25 percent by weight of the solid contents and a two-component aliphatic polyurethane acrylic emulsion by 6 to 10 percent by weight of the solid contents,
drying with heat the coated surface under a temperature condition of 70° C. to 130° C., and
forming a coating film constituted by solid contents including 51 to 55 percent by weight of a two-component aliphatic polyurethane, 3 to 7 percent by weight of silica fine particles, 23 to 37 percent by weight of a cross-linking agent and 7 to 13 percent by weight of a silicone-based touch agent (the solid contents of the sum of each component gives 100 percent by weight), and which contains in the two-component polyurethane a polyurethane resin matting agent by 12 to 25 percent by weight of the solid contents and a two-component aliphatic polyurethane acrylic emulsion by 6 to 10 percent by weight of the solid contents is formed.
